(19) United States
(12) Patent Application Publication
(10) Pub. No.: US 2012/0203791 A1
(43) Pub. Date: Aug. 9, 2012

(54) CORPORATE DASHBOARD FOR EXAMINER INFORMATION SYSTEM

(75) Inventor: Christopher L. Holt, Edina, MN (US)

(73) Assignee: Ficus Enterprises LLC, Edina, MN (US)

(21) Appl. No.: 13/336,087

(22) Filed: Dec. 23, 2011

Related U.S. Application Data
(63) Continuation-in-part of application No. 13/153,572, filed on Jun. 6, 2011.
Application No. 13/153,572 is a continuation-in-part of application No. 11/823,557, filed on Jun. 28, 2007.
Application No. 11/823,557 is a continuation of application No. 11/801,799, filed on May 11, 2007.
Application No. 11/801,799 is a continuation of application No. 11/487,526, filed on Jul. 14, 2006.

(51) Int. Cl. G06F 17/30

(52) U.S. Cl. 707/758; 707/E17.014

(57) ABSTRACT

A patent Examiner information accessing system is disclosed for accessing patent Examiner information from a Patent and Trademark Office, or other, database. A search system is provided so that a user can search information aggregated by the Examiner information accessing system.

### CROSS-REFERENCE TO RELATED APPLICATION

The present application is a continuation-in-part of, and claims priority of, U.S. patent application Ser. No. 13/153,572, filed Jun. 6, 2011 entitled USER INTERFACE AND PROCESSING FUNCTIONALITY FOR PATENT EXAMINER INFORMATION SYSTEM, and claims priority of and is a continuation-in-part of, U.S. patent application Ser. No. 11/823,557, filed Jun. 28, 2007 entitled EXAMINER INFORMATION SYSTEM, and claims priority of and is a continuation of, U.S. patent application Ser. No. 11/801,799, filed May 11, 2007 entitled EXAMINER INFORMATION SYSTEM, and the present application is also a continuation-in-part of, and claims priority of, U.S. patent application Ser. No. 11/487,526, filed Jul. 14, 2006, entitled SYSTEM AND METHODS FOR PROVIDING INFORMATION ABOUT PATENT EXAMINERS, the content of these applications being hereby incorporated by reference in their entirety.

### BACKGROUND

It is natural for a person who is tasked with influencing a decision-maker to be curious about the decision-maker's background. Further, if the person is pre-equipped with insight into the decision-maker's previous decisions, this could give an advantage in terms of the person's ability to effectively advocate for a particular outcome. It comes as no surprise that entire industries have sprung up around providing information about decision-makers.

An attorney who is to appear before a judge has a variety of resources available from which information about the judge can be learned. For example, it is generally not difficult for the attorney to obtain previous written opinions authored by the judge. In fact, it is relatively easy to obtain previous written opinions specifically dealing with topics that are on-point or similar to the attorney's current needs or interests. There are well-known commercial and public resources for acquiring this type of information.

Further, there are a variety of resources available that provide information related to a given judge's personal background. In some jurisdictions, there are court web sites that provide background information about judges. Periodicals, such as those published by bar associations, often publish interviews and/or judicial profiles. In addition, certain specialized commercial and public informational services provide the public with background information about lawyers and/or judges.

Another kind of decision maker is a patent Examiner. A patent Examiner, typically an employee of a patent office, is tasked with reviewing patent applications and making decisions related to the patent process. An Examiner is typically tasked with, among other things, deciding how many inventions are claimed in a given application, deciding whether the application satisfies certain formal requirements, deciding whether a patent should be granted to cover any invention claimed in the application, and deciding the scope of any patent to be granted.

In many countries, including the United States, as a patent Examiner makes decisions during the patenting process, an inventor and/or an advocate (e.g., a representative of an inventor and/or a representative of an assignee of an inventor's rights) is given opportunities to interact with the Examiner. At least some of these interactions represent opportunities to urge the Examiner toward a particular outcome or decision.

Under the circumstances, it is natural for a person who is tasked with interacting with a patent Examiner to be curious about the Examiner's background and/or previous decisions. Unfortunately, at least in the United States, there is currently no convenient way to efficiently gather information on an Examiner-specific basis. In fact, it is not uncommon for an inventor or an advocate to know very little about the Examiner with whom they are interacting during the process of moving a patent application through the patenting process.

### SUMMARY

A patent Examiner information accessing system is disclosed for accessing patent Examiner information from a Patent and Trademark Office, or other, database. A search system is provided so that a user can search information aggregated by the Examiner information accessing system.

### BRIEF DESCRIPTION OF THE DRAWINGS

FIGS. 1A and 1B (FIG. 1) are a block diagram of one information accessing system in accordance with one embodiment.

FIGS. 2-14 are user interfaces that illustrate embodiments of the operation of the system shown in FIG. 1.

FIG. 15 is a flow diagram illustrating one embodiment of providing report or consultation services.

FIG. 16 is a block diagram of a data accessing system in greater detail.

FIG. 17 shows one embodiment of a screenshot that illustrates a login screen.

FIG. 18 is a screen shot showing one embodiment of a search page.

FIG. 19 shows one illustrative set of results returned in response to submitting a search query.

FIGS. 20A-20D show a user interface display illustrating various embodiments of a set of statistics that can be returned for a given Examiner.

FIG. 21 illustrates a user interface display showing one embodiment of selecting one of the results shown in FIG. 20B.

FIGS. 22A and 22B show a user interface illustrating one embodiment of a display generated when selecting a “Compare” button in FIG. 20A.

FIG. 23 is a user interface display illustrating one embodiment of a results page for an Examiner for which there are insufficient statistics to compare against other Examiners.

FIG. 24 is a user interface display illustrating one embodiment of a screen that is displayed when a button is selected in FIG. 23.

FIG. 25 is one illustrative user interface.

FIG. 26 is one illustrative flow diagram showing operation in scoping data.

FIG. 27-29 are block diagrams of illustrative screenshots.

FIGS. 30A-30B show an illustrative screenshot of an enterprise dashboard.

FIG. 31 is a block diagram of one illustrative customization system.

FIG. 32 is a flow diagram showing illustrative operation of the system shown in FIG. 31.

FIG. 33 is one illustrative customization interface.

FIGS. 34 and 35 are examples of estimation interfaces.

Appendices A-E show embodiments of a Patent and Trademark Office interface that makes patented data available to the aggregation system.

Appendix F illustrates various embodiments that can be used on a search interface.

### DETAILED DESCRIPTION

System 100 includes an Examiner information accessing system 102 that accesses Examiner data through Examiner data system 104. Examiner information accessing system 102 aggregates data and can index it in a variety of different ways, illustratively one way is by Examiner, and stores it in aggregated Examiner data store 106. It will be noted that data store 106 can be integrated within Examiner information accessing system 102 or separate therefrom.

In any case, search user interface system 108 is also shown coupled to system 102. Search user interface system 108 generates search user interfaces 110 for use by a user 112 through a network 114. A variety of different embodiments of user interface 110 are described below. They assist in illustrating the operation of system 100.

In one embodiment, user 112 wishes to obtain information from aggregated Examiner data store 106. For instance, assume that user 112 is a patent attorney that is prosecuting a patent application before a given Examiner. The patent attorney (user 112) may wish to view Office Actions issued by that Examiner in similar cases, using similar prior art, or using similar rejections, or all of the above. User 112 will thus illustratively provide a query 116 through an interface (search UI) 110 that is generated by search user interface system 108.

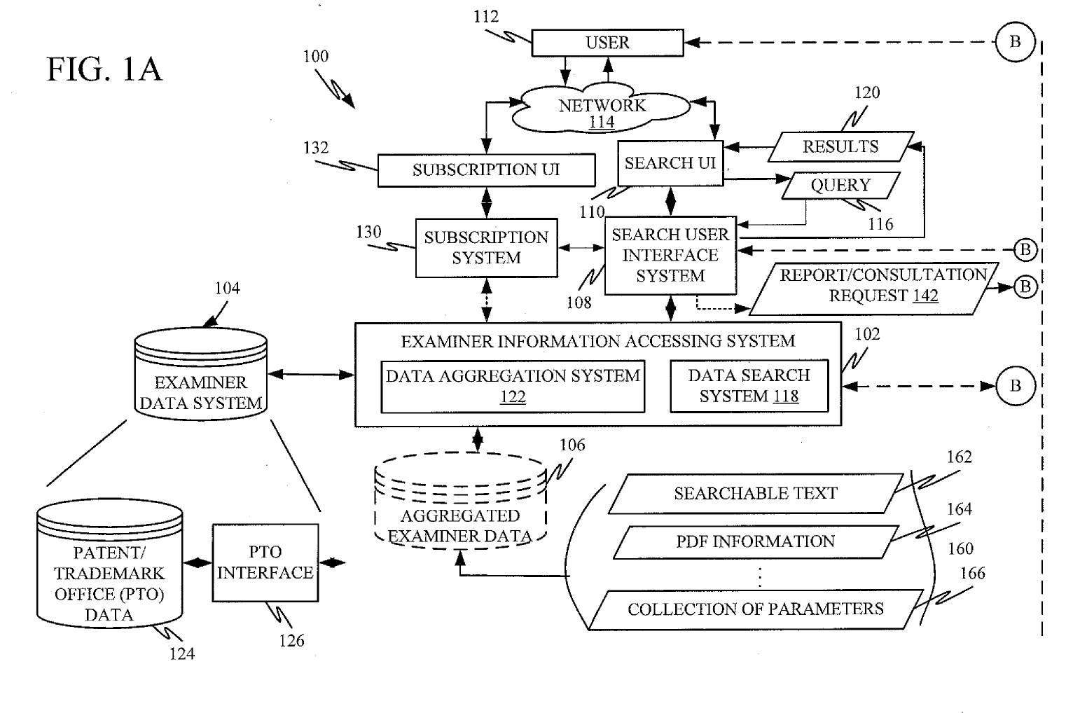

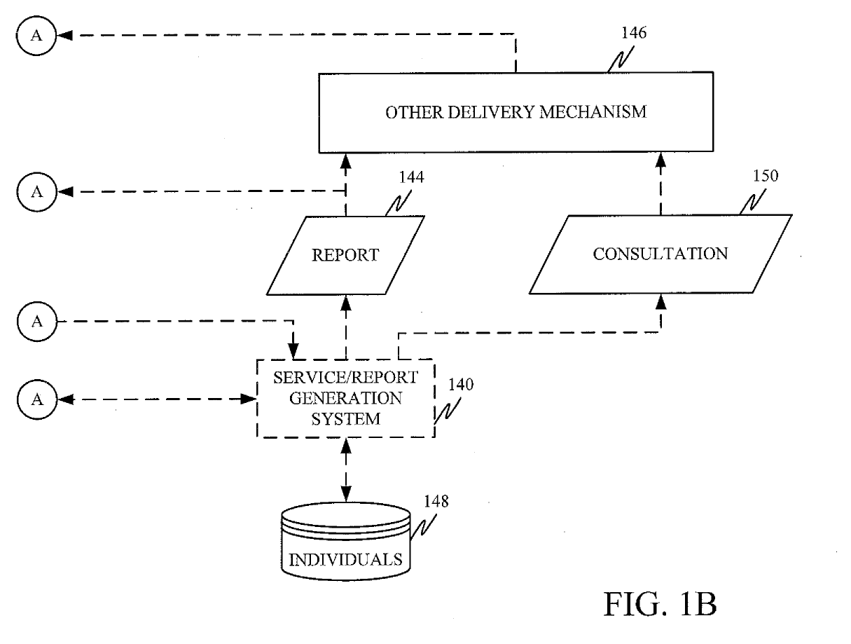

FIG. 1 shows that Examiner information accessing system 102 includes a data search system 118 and data aggregation system 122. Various components shown in FIG. 1 can be implemented in a computer processor, with associated timing and computer readable storage media and memory circuitry. While those components are not individually called out in FIG. 1, they are illustratively functional parts of, and activated by, systems 102, 108, 130, 104, 146, 140 and client devices used by user 112. Further, the methods and computer readable instructions discussed herein can illustratively be implemented by a processor reading the instructions from the storage media. In any case, query 116 is provided to data search system 118 which, in turn, executes the query against aggregated Examiner data 106 (though it should be noted that it is also within the scope of the scope of the present invention for the queries to executed against another collection of data such as but not limited to data associated with an examiner data system 104, which will be described in greater detail below). The data search system 118 may illustratively be a conventional search engine or another type of searching system that searches through aggregated Examiner data 106. In any case, data search system 118 generates results 120 that are provided, through search user interface system 108, and through the search UI 110 generated by system 108, to a user over network 114. The query 116 and results 120 can contain any of a wide variety of different information, depending on what the user 112 desires, and depending on the type of data aggregated in aggregated Examiner data store 106.

In order to aggregate that data, Examiner information accessing system 102 illustratively includes data aggregation system 122. Data aggregation system 122 accesses, and extracts, some of the data in Examiner data system 104. In one embodiment, system 104 includes Patent/Trademark Office (PTO) data stored in data store 124 which is accessed through PTO interface 126 that is exposed by the United States Patent and Trademark Office. Of course, the source of the data aggregated by data aggregation system 122 and stored in data store 106 can be a different source, other than the United States Patent and Trademark Office database system. For instance, it may be a separate entity that has purchased or otherwise obtained data from the United States Patent and Trademark Office, or it might be that aggregated Examiner data 106 is purchased or otherwise obtained directly from the United States Patent Office, without aggregating the data using data aggregation system 122.

In any case, however, aggregated Examiner data 106 illustratively includes some embodiments of which are indicated by numeral 160. For example, the data can include searchable text 162. The searchable text may illustratively be the text of the Office Actions and/or responses to Office Actions stored in the file histories for various patent applications, indexed by a collection of different search parameters 166. For instance, the collection of parameters which define how the information can be searched may include keywords, the Examiner name, the attorney name who is handling the case, types of rejections which the Examiner has used (such as rejections under 35 U.S.C. §101, 102, 103, 112, etc.). The type of parameters that can be used in searching aggregated Examiner data 106 will be described in more detail below, by way of example. Data 106 may also illustratively include PDF information 164, such as PDF images of various items in the file histories of various patent applications, the data for which is stored in aggregated Examiner data 106.

It will also be noted that where free text searching is provided (described in more detail below), the data in store 106 need not be indexed by the search parameters, but instead a text search is simply performed during runtime. However, indexing may be desired as well (i.e., in combination with free text searching).

To give further examples of the types of data that can be aggregated into store 106, Appendices A-E illustrate various types of PTO data 124 that are currently available, and that could be obtained using data aggregation system 122. The types of data also illustrate the various types of parameters 166 that can be used for searching.

Appendix A shows that, for a given serial number (here the serial number is a fictitious Ser. No. 10/012,345) a title is given, here the title is “Stalling Instructions in a Pipeline Microprocessor”. In Appendix A, bibliographic data for that serial number is listed. The bibliographic data includes the application number, the filing date, the application type (such as utility, plant, design, etc.), the Examiner name, the group art unit, the confirmation number, the attorney docket number, the class/subclass for this serial number, the first named inventor, the customer number, the status of the application, the date on which the status was last updated, the location within the Patent Office of the file, the date on which the location was last updated, the earliest publication number of the application, the earliest publication date, the patent number and issue date of the patent, if any. All of this information is obtainable and all, or any, of it may be aggregated into data store 106, as desired. Any of this information can be implemented as a searchable parameter and made available to user 112 as a basis for formulating a search.

Appendix B illustrates more information that can be aggregated in aggregated Examiner data store 106. Again, for a given serial number, a transaction history is available in PTO data 124. The transaction history (one of which is shown in Appendix B) includes a date column and a transaction description column. The date column indicates the date of the transaction identified by the transaction description. Of course, any of the transactions may be interesting to a given user 112. Of note, however, are the rejections issued by the Examiner, and whether they were final or non-final rejections, whether the case is abandoned, etc. A wide variety of different transactions can be described in the transaction history shown in Appendix B and those listed are listed for the sake of example only. Any of this information can be implemented as a searchable parameter and made available to user 112 as a basis for formulating a search.

Appendix C identifies continuity data associated with the listed serial number. The continuity data indicates whether any child continuity data has been listed for this application, and the status of the parent case, along with the patent number of the parent case, if any. Any of this information can be implemented as a searchable parameter and made available to user 112 as a basis for formulating a search.

Appendix D shows publication dates and details associated with those dates for the listed serial number. Any of this information can be implemented as a searchable parameter and made available to user 112 as a basis for formulating a search.

Appendix E shows the attorney or agent and correspondence information associated with the serial number. Of course, the information listed in Appendix E is fictitious and is used for the sake of example only. Any of this information can be implemented as a searchable parameter and made available to user 112 as a basis for formulating a search.

Other information available from the PTO data store 124 may illustratively include the images of the items in the file wrapper for the given serial number. For instance, there may be PDF or other images available for all items of correspondence between the Patent Office and the applicant, or the attorney/agent of record. Some of those items may include, for example, the application itself, information disclosure statements, office actions, restriction requirements, all correspondence from the Patent Office, responses to those items of correspondence from the applicant, attorney or agent, notices of allowance or abandonment, reexamination request, request for reissue, and all other items of information exchanged between the patent and agent, or third parties, including the issued patent itself.

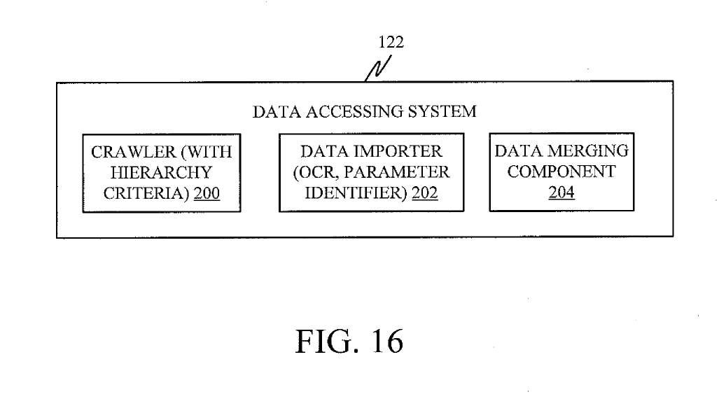

In accessing these types of images, data aggregation system 122 illustratively converts at least some of them to searchable text 162. One embodiment for doing this involves an embodiment of data accessing system 122 shown in FIG. 16. FIG. 16 is a more detailed block diagram of data accessing system 122 and illustratively includes crawler 200, data importer (which may be an optical character recognition OCR parameter identifier) 202, and data merging component 204.

Crawler 200 illustratively includes a spider that continuously or periodically, crawls through PTO data 124 to aggregate data in data store 106. Crawler 200 can illustratively be directed by a hierarchy of aggregation criteria which indicates what types of information crawler 200 is to download in a preferential order. For instance, in one embodiment, crawler 200 can be directed to first download all of the documents associated with a given list of serial numbers. Alternatively, or in hierarchical order, crawler 200 may be directed to download information for a list of assignees, inventors, dates, group art units, based on the named inventor, classes or subclasses where applications are classified, etc. The hierarchical criteria used for aggregating the data can be any criteria desired and the hierarchical criteria can be arranged in any hierarchy desired. Those listed are simply listed by way of example.

Accordingly, if it is desired that crawler 200 aggregate the most recent data first, then the first aggregation criteria listed might be the date or date range of interest. In that case, crawler 200 will focus on downloading information for serial numbers of applications that have been filed most recently or applications that have been pending the longest. If the next criteria in the hierarchy is a group art unit, then crawler 200 will focus more preferentially on aggregating data corresponding to the most recent information in the designated group art unit. Of course, the aggregation criteria need not be hierarchical but could simply be flat in which case assuming that crawler 200 is to download the most recent information first, it downloads all information within a given date range and then focuses on the next criteria such as the information in a given art unit. Any desired combination of aggregation criteria can be used, including a single criterion.

In one embodiment, crawler 200 is configured to check the file histories of different serial numbers so as to determine if an office action not already included in data 106 has issued. If there is such a document, crawler 200 illustratively adds it to data 106. In one embodiment, crawler 200 is configured to implement preferences in terms of which serial numbers get checked first for updates. In one example of such a preference, cases where an office action has issued recently but a patent has not issued are placed higher in cue for update checking than cases where a substantive office action has not yet been issued. In another example, cases that have been pending longer are given priority. In another example, certain art units, are given a preference. In another example, cases where patents have issued or prosecution has been abandoned are eliminated from the update cue. Any of these examples of preferences can be imposed individually or in combination with one another. Of course, the scope of the present invention is not limited to these examples.

Crawler 200 may also be equipped to avoid accessing PTO data 124 during busy times (e.g., during PTO business hours). Further, crawler 200 may be configured to only access information at a rate that does not appreciably slow down the response time of system 104 (e.g., based on server response time or some other factor).

Data importer 202 illustratively receives the information aggregated by crawler 200 and generates corresponding searchable text 164, and also identifies and collects parameters 166 that can be used as the basis of a search. For instance, in one embodiment, a large amount of data in PTO data 124 is only available for aggregation in PDF format, or in an image format (e.g., TIFF, JPEG, etc.), or in some other format where text is not readily available. In one scenario, office action and response documents are electronically scanned into PTO data stores 124 and reside there as image files until requested, at which time they are delivered as image files or in another format such as PDF. Thus, these documents are not made available in a conveniently text searchable format. In that case, in one embodiment, data importer 202 performs optical character recognition on the documents to recognize the text in the documents and generate a searchable text version.

Data importer 202 illustratively also includes a parameter identifier component that identifies and collects various search parameters that may be used by user 112 in searching the aggregated data. Of course, the parameters can be used to index the data, or simply stored in a table (or other data structure) associated with each stored document. Also, a parameter can be identified by application of a comparison or classification model (e.g., a text comparison model applied to classify a document based on its textual content, one or more parameters being assigned accordingly) or in any other desired way at other points in the processing of the accessed documents. For instance, in one embodiment, the parameter identifier in data importer 202 illustratively looks for terms such as, but not limited to, the Examiner's name, “§101”, “§102”, “§103”, “§112”, “restriction requirement”, “double patenting”, recitations of statutory texts or rules, etc. The parameters may also be more specific such as “35 U.S.C. §102(b)”, “35 U.S.C. §102(e)”, or they may be less specific, such as “102”. The parameter identifier in data importer 202 will also, illustratively, identify any other parameters which will be searchable by a user, such as keywords, group art unit number, assignee name, etc. Of course, the list of parameters is virtually endless and any of those made available in PTO data 124 can be used in accordance with the present system. Also, importer 202 may generate a text searchable version of the aggregated data and retain the original data (such as the PDF version) as well.

Alternatively, some or all of the parameters need not be identified by importer 202. In one embodiment, importer 202 simply converts the aggregated data into text searchable form, and may retain the original version of the data, as desired.

In one embodiment, data accessing system 122 also includes a data merging component 204. It may happen, for instance, that the individual pages of documents in PTO data 124 are made available as separate PDF (or other) images. For example, the individual pages of an Office Action may illustratively be stored as separate image files and delivered as separated PDF images. In circumstances such as these, data merging component 204 illustratively identifies the various pages that correspond to a single document (such as all pages belonging to an individual Office Action) and merges them into a single text readable document, or a single PDF document, or both, and stores that document in aggregated Examiner data store 106.

Referring again to FIG. 1, it may be desirable to have user 112 subscribe to use system 102. In that case, subscription system 130 is provided and generates subscription user interface (subscription UI) 132 which can be used by user 112 to subscribe to use system 102. In one illustrative embodiment, subscription system 130 generates UI 132 so that it collects identification information, authentication information, and billing information from user 112 such that user 112 can either pay for, or be billed for, its use of system 102. Search system 108 illustratively requires a user 112 to log on, or otherwise validate its identity. That information can then be used by subscription system 130 to determine whether user 112 has a valid subscription. If so, subscription system 130 can authorize system 102 and system 108 to continue, and allow user 112 to execute searches, or to otherwise use system 102. If not, system 130 can offer user 112 the opportunity to subscribe, or can simply terminate the session and not respond to the request of user 112, or to respond with an explanation that the user has not subscribed, etc.

FIG. 1 also illustrates another illustrative embodiment in which optional service/report generation system 140 can be used to generate a report requested by user 112, or to offer consultation services requested by user 112. For instance, it may be that user 112 simply desires a statistical report that can be generated from the aggregated Examiner data 106. One exemplary report may be an indication of how often an Examiner is reversed on appeal, how often the Examiner has issued any given rejection, (such as rejections under any subdivisions of 35 U.S.C. §101, 102, 103, 112, etc.), how often a given Examiner (or set of Examiners within a given art unit) are issuing restriction requirements, or any of a wide variety of different types of statistical or other reports. Similarly, user 112 may desire a more detailed report, such as a summary of various responses that have been used to overcome office actions that include rejections based on a certain statutory section, or based on certain prior art references, issued by a given Examiner.

If user 112 desires such a report, user 112 illustratively submits a report/consultation request 142 through an appropriate user interface generated by search user interface system 108, to service/report generation system 140. System 140 illustratively includes the components required to obtain the necessary information (such as to generate necessary queries and aggregate necessary results) with respect to Examiner information accessing system 102. Where the user desires a summary of some type, system 140 or system 102 illustratively includes a summarizing component, such as a natural language processing system that automatically summarizes text. Once the information is obtained, service/report generation system 140 illustratively generates the desired report 144 and provides it back to the user 112 through system 108, or through other delivery mechanism 146. In some, various embodiments, other delivery mechanism 146 may include electronic mail (email), automated telephone messaging, or telephone call, tele-facsimile (i.e., fax), US mail or other delivery service, etc.

In another embodiment, user 112 may wish to have consultation services, in addition to or instead of, report 144. Service/report generation system 140 illustratively maintains a data store of individuals 148 that are particularly knowledgeable about certain Examiners, about certain group art units, about certain subject matter, etc. This data store of individuals 148 can be generated by system 140 in a variety of different ways. For instance, system 140 might simply generate data store of individuals 148 statistically by identifying particular attorneys or agents that consistently have cases before given Examiners, in a given art unit, with a given subject matter, etc. System 140 may also recruit individuals or allow individuals to register as “experts” or simply “consultants” in certain areas or with respect to certain parameters (such as, again, Examiners, group art units, types of rejections, etc.).

In such a system, report/consultation request 142 is received, through an appropriate user interface generated by system 108, from the user. The report/consultation request 142 identifies the parameters which are sought for consultation, and system 140 illustratively identifies individuals from data store of individuals 148 that may be suited to provide consultation services to user 112, given the consultation parameters indicated in report/consultation request 142 (alternatively, request 142 may direct a request to a given consultant as well). System 140 may then illustratively automatically contact a subset of individuals 148 that may be useful in providing the requested consultation services. That contact can be made manually by an administrator or other individual working in system 140, automatically through an automated telephone call, electronic mail message, paging message, by a tele-facsimile, etc. In any case, once an individual has agreed to provide consultation services, that individual provides consultation 150 to user 112, either as specified by the user, or as desired by the consultant, or in any other desired way. For instance, it may be that the individual identified to provide the consultation 150 simply calls the user 112 at a telephone number indicated in the report/consultation request 142. Alternatively, the individual may send an email to the user 112, fax the user 112, exchange messages through a chat room or bulletin board, provide information through a proprietary, and confidential web site, etc. A wide variety of different ways of providing consultation 150 can be used.

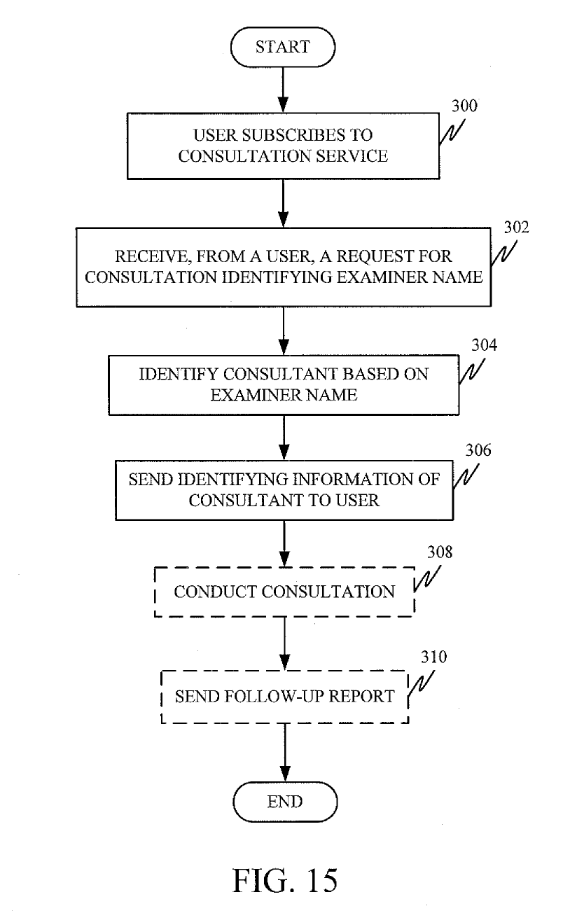

FIG. 15 is a flow diagram better illustrating one embodiment of providing consultation services. In FIG. 15, the user first subscribes to receive consultation services through subscription system 130. This is indicated by block 300. Next, system 140 receives, from user 112, a request for consultation identifying the information for which consultation is sought. In the embodiment set out in FIG. 15, the user 112 desires consultation regarding an individual Examiner, such as how to overcome rejections by the Examiner, how to conduct interviews with the Examiner, etc. Receiving the request is indicated by block 302 in FIG. 15. Next, system 140 identifies a consultant based upon the parameters for which consultation services are sought (in one embodiment, the parameters include the Examiner name). This is indicated by block 304 in FIG. 15. In the embodiment shown in FIG. 15, system 140 then sends to user 112 identifying information, identifying the consultant which is to be used in providing the consultation 150. This is indicated by block 306. The user may then contact the consultant, the consultant may contact the user, or both, and the consultation is conducted. This is indicated by block 308 in FIG. 15. The consultant may also desire to send a follow up report or user 112 may request a follow up report, summarizing the consultation. This is indicated by block 310 in FIG. 15. Of course, a wide variety of other methods can be employed to provide consultation services.

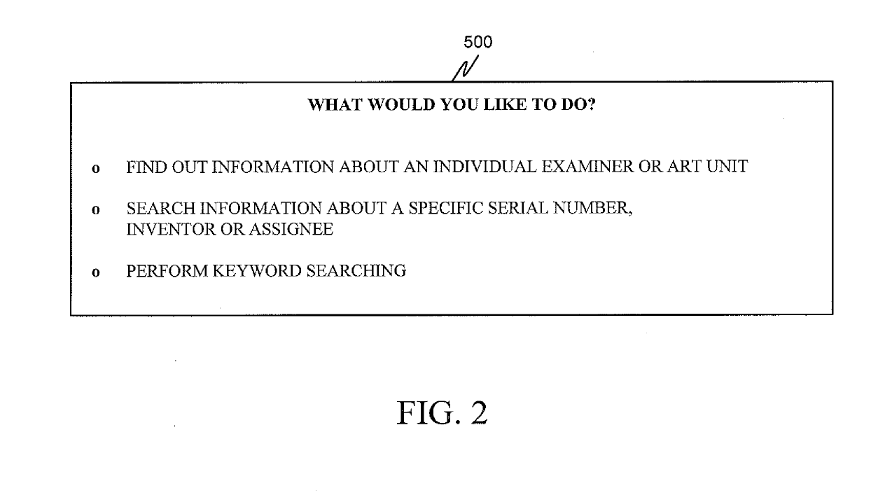

FIGS. 2-14 show a variety of different user interfaces which can be generated by system 108. These user interfaces are exemplary only and are used to illustrate one embodiment of the operation of system 100.

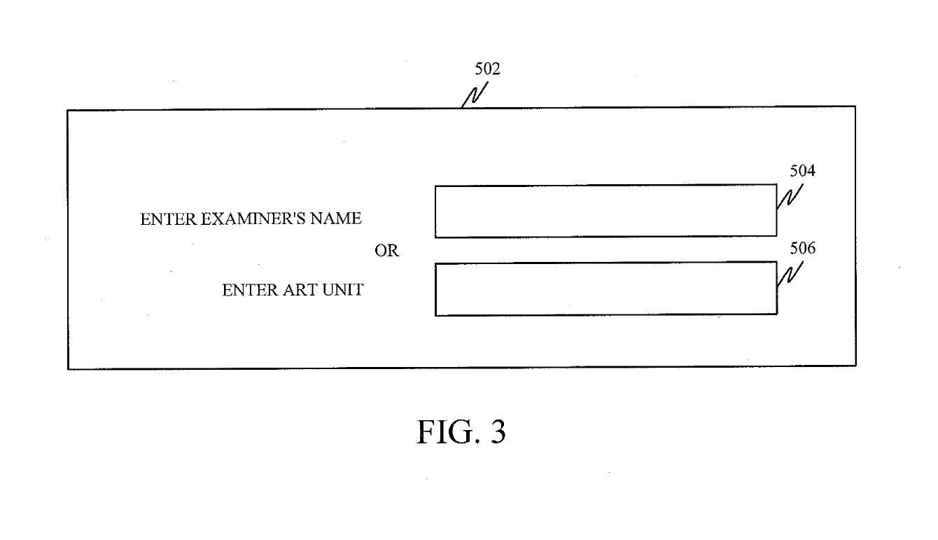

Assume a user 112 first logs onto or otherwise desires to access system 102. User interface system 108 may illustratively provide a first user interface, such as user interface 500 shown in FIG. 2. User interface 500 asks the user what the user would like to do and then presents a number of different radio buttons that can be selected by the user. For instance, in the embodiment shown in FIG. 2, the radio buttons ask the user if the user desires to: “find out information about an individual Examiner or art unit”, “search information about a specific serial number, inventor, or assignee”, and “perform keyword searching”. Assume that the user selects the first button and desires to find out information about an individual Examiner or art unit. In that case, system 108 presents the user with a more detailed selection user interface, such as that set out as 502 in FIG. 3. User interface 502 allows the user 112 to enter an Examiner's name in box 504 or an art unit number in box 506.

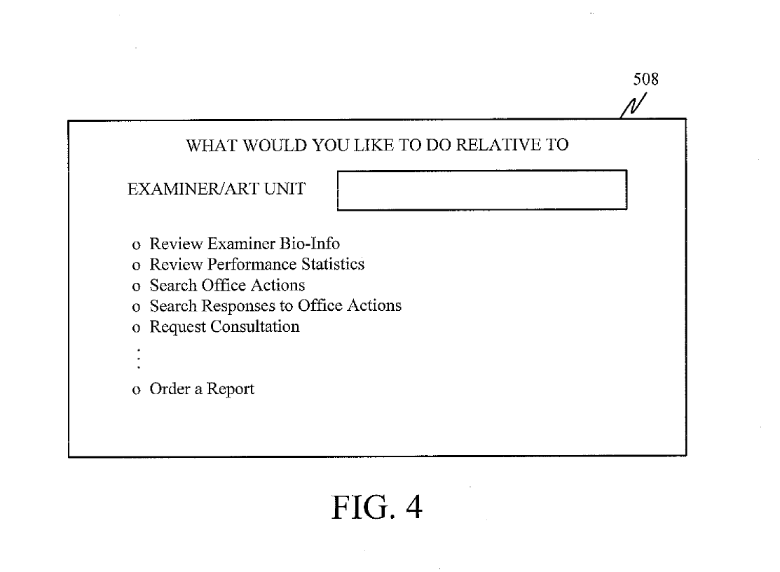

Assuming that the user enters an Examiner's name, user interface system 102 presents another user interface which asks the user 112 a more detailed question about what the user would like to do. One embodiment of this is shown at 508 in FIG. 4. User interface 508 in FIG. 4 asks the user what the user would like to do relative to the Examiner or art unit identified at user interface 502 in FIG. 3. Assume, for instance, in FIG. 3, the user has entered a particular Examiner's name in box 504. The user interface 508 in FIG. 4 then allows the user to review the Examiner's biographical information, review performance statistics for the Examiner, search office actions for that Examiner, search responses to office actions for that Examiner, request a consultation for that Examiner, order a report for that Examiner, etc. A wide variety of other things could be requested as well, and those listed in FIG. 4 are exemplary only. It will also be noted that the same, or similar options can be provided if the user enters an art unit in box 506 of user interface 502 shown in FIG. 3 (e.g., similar options but scoped to an art unit rather than to a particular examiner). It should also be noted that to the extent that the present description refers to scoping based on art unit, the scope of the present invention is not so limited. It is within the scope of the invention to facilitate research of groups of examiners based not just on art unit but on any other basis for grouping examiners.

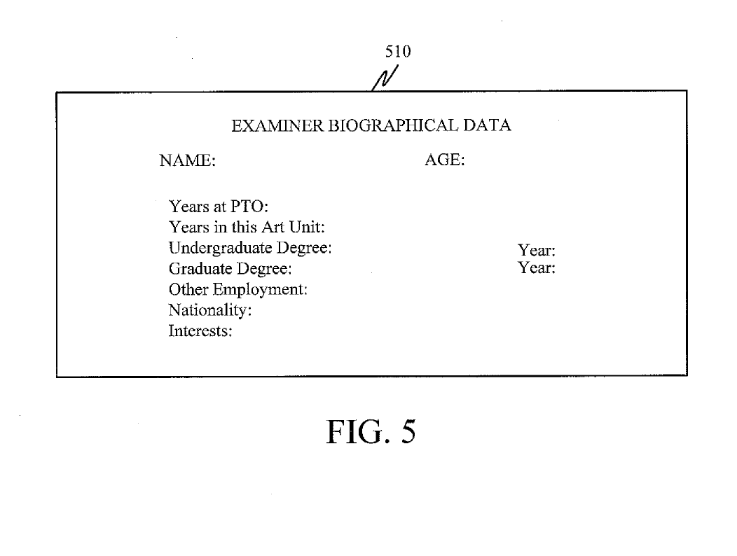

Assume that the user has requested to review the Examiner biographical information in FIG. 4. Data search system 118 then executes a predefined query to obtain the biographical information for the Examiner entered in the user interface in FIG. 3. User interface system 108 then presents a user interface, such as user interface 510 shown in FIG. 5, to user 112. User interface 510 simply lists a variety of Examiner biographical data for the given Examiner. The Examiner biographical information may be obtained directly from the Examiner, from the Patent Office data 124, by recruiting Examiners to enter their information, or by any other desired means. The biographical data is illustratively stored within database 106 and made available for retrieval by search system 118.

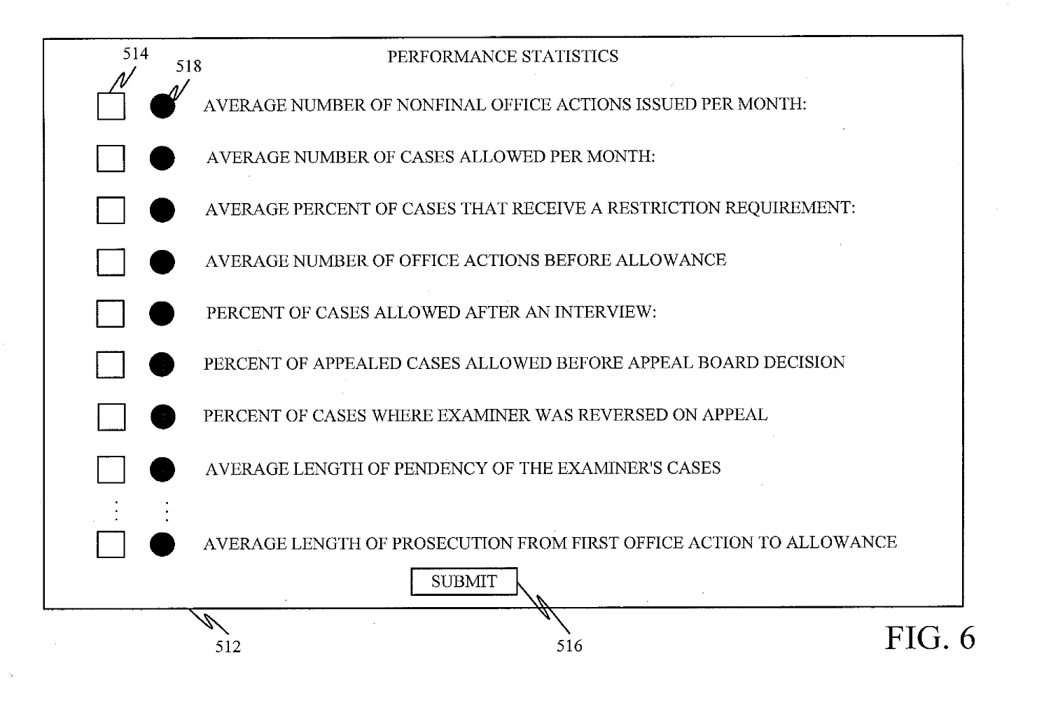

Assume that, in FIG. 4, the user has selected to review performance statistics for the identified Examiner. In that case, search user interface system 108 then presents another user interface to the user, specifically requesting that the user identify, or select, the various statistics which the user would like to review. One embodiment of such an interface is indicated by 512 in FIG. 6. In the embodiment shown in user interface 512, the user can either select a plurality of different types of statistics by hovering a cursor over check boxes 514 and selecting them (to place a check in them) and then, once all desired statistics are checked, actuate submit button 516.

Data search system 118 illustratively has the statistics for each of the Examiners precomputed and stored either in data store 106 or a separate data store of precomputed statistics. In that case, data search system 118 simply retrieves the selected statistics desired by the user and presents them, through an appropriate user interface generated by system 108, as results 120 to user 112. Alternatively, of course, data search system 118 need not have all, or any, of the statistics precomputed. System 118 will illustratively execute the necessary pre-formed queries against aggregated Examiner data 106 to generate the statistics desired by the user, and then present them to the user in a similar way. Alternatively, of course, data search system 118 may provide the performance statistics to report generation system 140 which generates a report 144 illustrating the statistics and provides that back to user 112 either through search user interface system 108 or through another delivery mechanism 146.

In another embodiment, in which the user actuates one of radio buttons 518, this causes data search system 118 to automatically generate (or retrieve) the statistics corresponding to that radio button and return them to the user either as a report, or through user interface system 108, or in any other desired way. Of course, the particular performance statistics listed in user interface 512 are exemplary only, and additional, or different, performance statistics can be provided as well. Those listed simply include the average number of non-final office actions issued by this Examiner per given unit of time (such as per month), the average number of cases allowed by this Examiner (e.g., per month), the average percentage of cases that receive a restriction requirement from this Examiner, the average number of office actions before allowance for this Examiner, the percent of this Examiner's cases allowed after an interview, the percent of this Examiner's cases that are appealed, the percent of this Examiner's appealed cases that are allowed before an Appeal Board decision, the percent of cases where the Examiner was reversed on appeal, the average length of pendency of this Examiner's cases, and the average length of prosecution from the first office action to allowance, for this Examiner, etc. Again, the statistics are exemplary only and different or additional statistics can be generated as well.

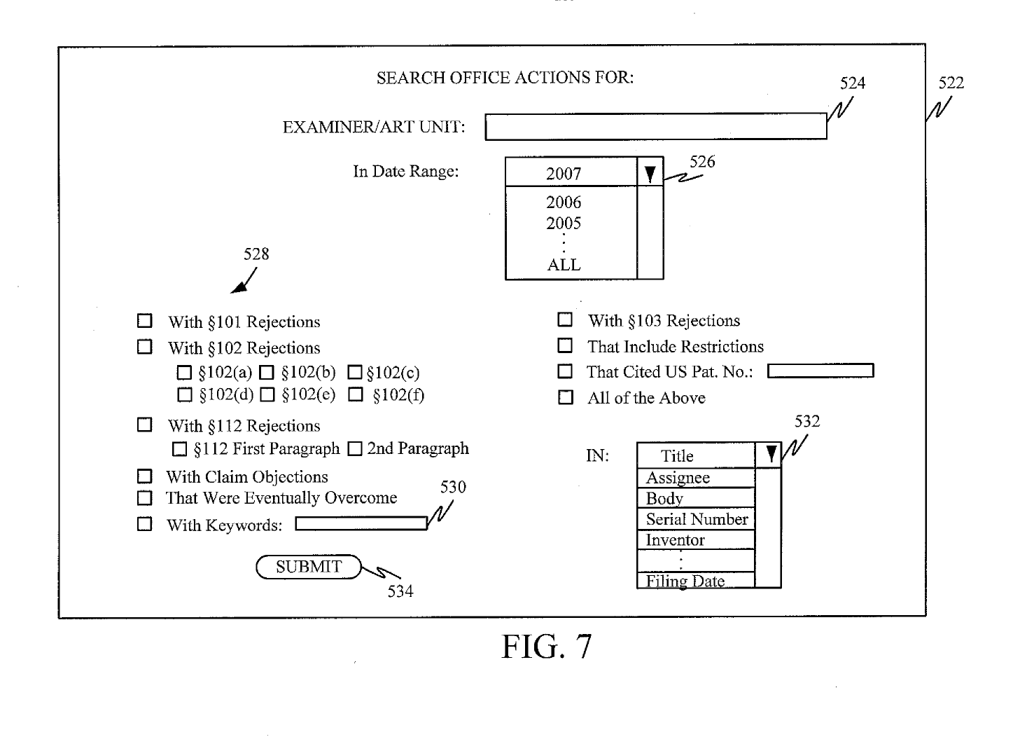

Assume that, in FIG. 4, the user has selected to search office actions for a given Examiner. System 108 then illustratively generates a user interface that allows the user 112 to more specifically identify the type of search which is to be conducted through the office actions. One such user interface is indicated by user interface 522 in FIG. 7. User interface 522 is an interface which allows a user to search office actions for the Examiner or art unit entered in user interface 502 in FIG. 3, and which will appear in box 524 in user interface 522. Again, the parameters which can be selected for searching the office actions shown in user interface 522 are exemplary only, and different or additional parameters can be used as well, and a different mechanism by which the parameters can be selected can be used also.

Those shown in the embodiment in FIG. 7 include a date range selection drop down menu 526 which allows a user to select a date range of office actions for this Examiner that are to be searched. Then, a plurality of different check boxes 528 are provided which allow the user to quickly and easily select the various parameters that the user desires to search for in the office actions issued by this Examiner. The parameters listed in FIG. 7 include, for instance, the different types of rejections made under the different statutory sections (such as §101, 102, 103, 112, etc.), and an even more detailed breakdown (such as which particular subparagraph under §102 of the rejection has been made, etc.), the office actions which include restriction requirements, the office actions that cited a particular patent number or other item of prior art, the office actions that contain claim objections, the office actions that were eventually overcome, or all of the above criteria.

In addition, user interface 522 allows the user to search for key words by simply checking the check box corresponding to the keyword field 530, and then entering desired keywords within field 530. The keywords can also be specified by indicating that they are located in a given portion of an office action by selecting a desired field from dropdown menu 532.

Once the particular search has been configured by selecting the various search parameters shown in user interface 522, the user can have the search conducted by actuating submit button 534. This causes data search system 118 to perform a search of the office actions for the identified Examiner. Of course, as with the performance statistics, data search system 118 can have some, none, or all of the information precomputed by performing searches offline, and storing the results of those searches for each individual Examiner (or for each other selected search parameter or criterion) in data store 106. Alternatively, of course, or where the data has not been precomputed, actuating submit button 534 causes data search system 118 to generate a query (or select one or more pre-formed queries) corresponding to the parameters selected in user interface 522, and launch that query against aggregated Examiner data 106 to obtain search results. Data search system 118 provides the search results to search user interface system 108 which provides them as results 120 through an appropriate search user interface 110 to user 112. Of course, as with the performance statistics, data search system 118 may provide the information to service/report generation system 140 which generates a report 144 and provides that to user 112.

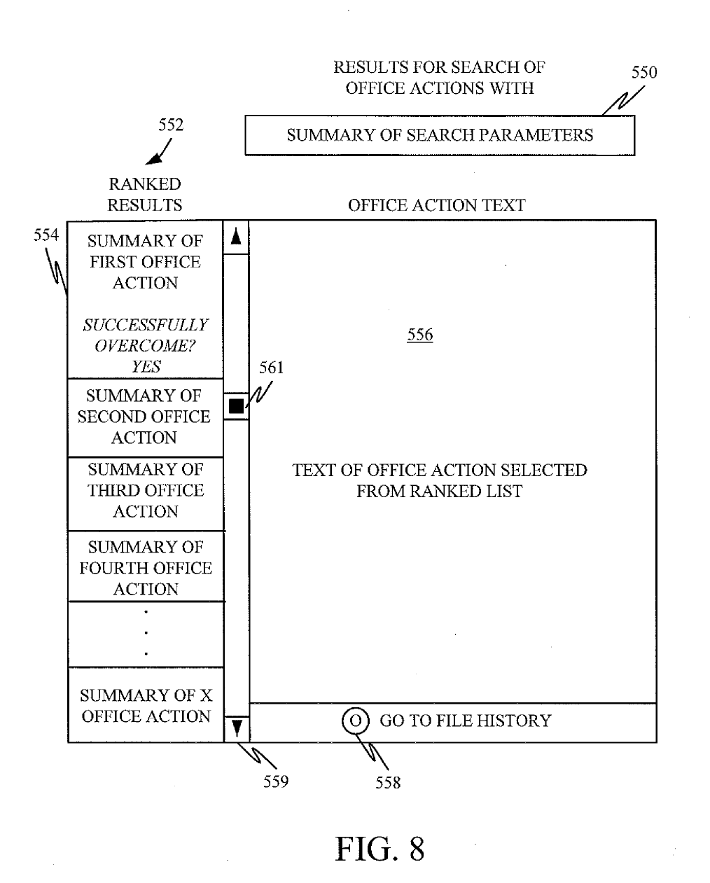

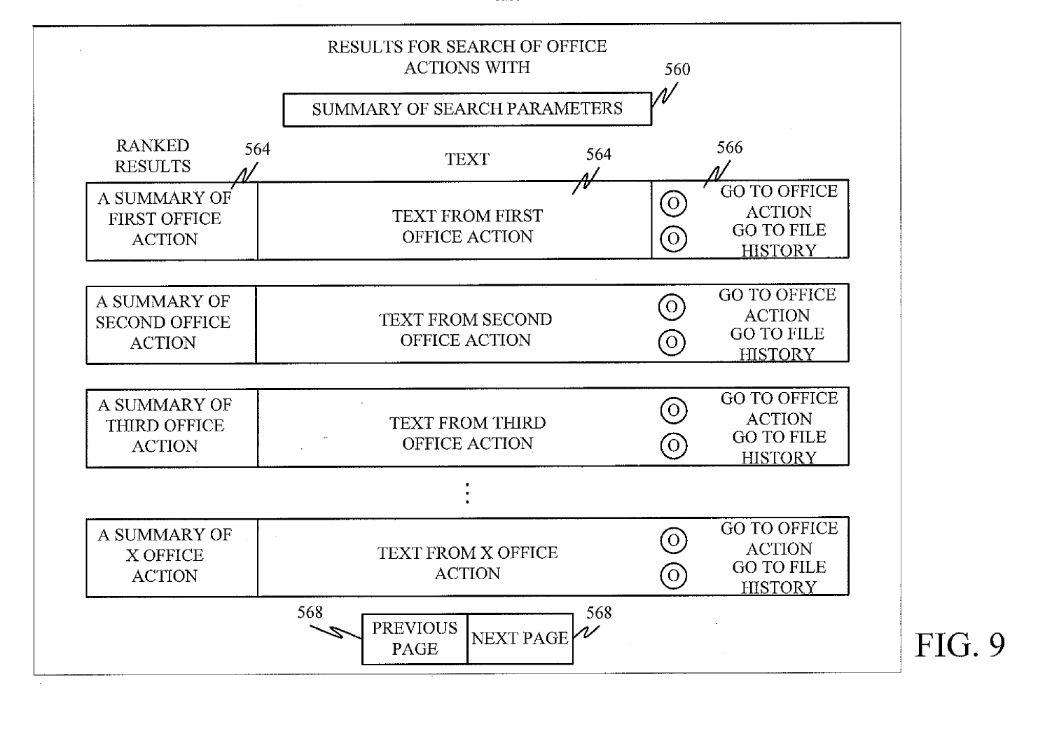

FIGS. 8 and 9 show two different embodiments of user interfaces that can be generated by system 108 based on the data returned by data search system 118, to present results 120 to the user. In FIG. 8, the user interface first includes a summary of the search parameters 550. This summary is illustratively generated in a field 550 and summarizes the various parameters selected at user interface 522, upon which the search was conducted. Below that, in FIG. 8, the results include a left hand ranked results column 552 that list the results, ranked by how closely they correspond to the search parameters. The ranked results are illustratively listed in boxes 554, which each include a summary of the office action and an indication as to whether the office action was successfully overcome by the applicant. The ranked list 552 can illustratively be scrolled using scroll buttons 559 or thumb 561. By hovering a cursor over one of the boxes 554, or by selecting the box, the full text of the corresponding office action illustratively appears in field 556. Thus, the user can simply select one of the boxes 554 on the left, and the corresponding full text of the office action corresponding to that box will appear in box 556. The user interface shown in FIG. 8 also illustratively includes a button 558, or some other mechanism, that allows the user to navigate to the file history that contains the selected office action (e.g., a pop-up box opens and shows a dated listing of documents in the file history, which the document associated with the button 558 being highlighted within the list to show context). This may be useful for a variety of reasons. For instance, assume that the user has reviewed the full text of the office action in box 556 and found it of interest. Assume also that the box 554 summarizing the office action contains an indication that this office action was successfully overcome by the Applicant. The user may wish to go to the file history to quickly review the response that was filed by the Applicant in order to overcome this office action. Of course, the user may desire to go to the file history for any of a wide variety of other reasons as well.

FIG. 9 shows another embodiment in which the results 120 are presented through a user interface to user 112. In the embodiment shown in FIG. 9, again the user interface shows a summary of the search parameters in field 560, and then has the ranked results listed, in rank order. However, the format of the presentation of the results is slightly different. Again, the results illustratively include a summary box 562 that summarizes the office action. The results shown in FIG. 9 also include a text box 564 that includes a portion of the text from the office action which contains the parameters that caused it to be present in the ranked list of results (NOTE: it should be noted that it is within the scope of the present invention for no text from the office action to be displayed at all or at least initially—e.g., only parameters and characteristics are shown on the results page—or at least the text is not shown unless requested through user input). Finally, the results include a navigation box 566 that allows a user to go to the full text office action or the file history that contains the office action (e.g., a pop up box opens and shows a dated listing of documents organized chronologically with the specific document associated with box 566 being highlighted to demonstrate context). The user can navigate between next and previous pages of search results using the next and previous page buttons 568.

While two embodiments of search results are shown in FIGS. 8 and 9, any of a wide variety of other embodiments for displaying search results can be used as well, and the present invention is not limited to those shown.

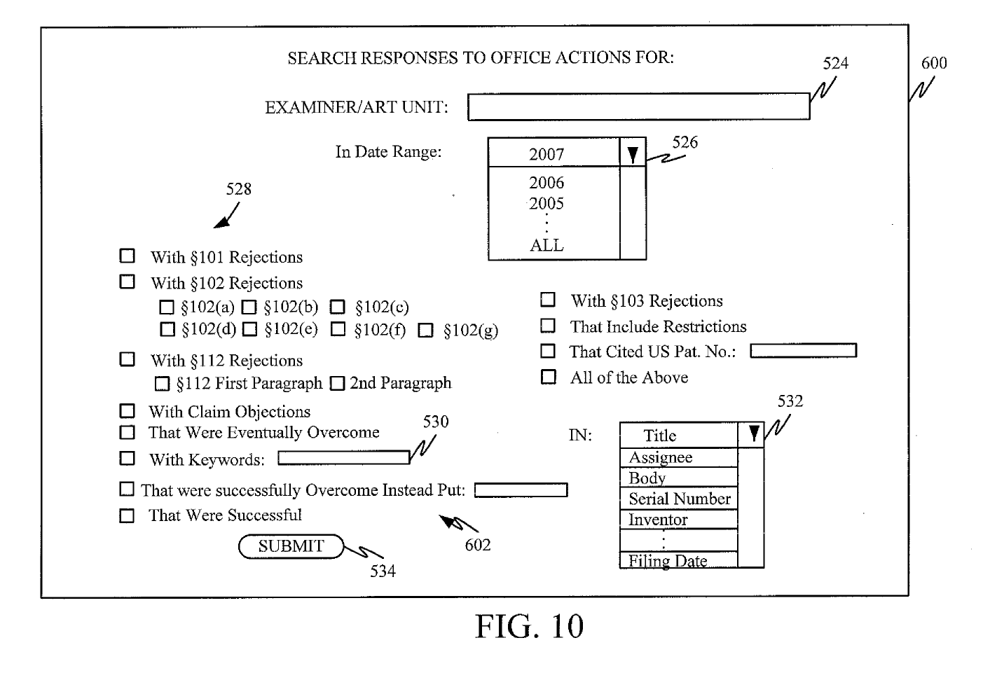

Now assume that in FIG. 4, the user has indicated that the user desires to search responses to office actions for the given Examiner. In that case, a system 108 illustratively again provides a user interface to the user, such as user interface 600 shown in FIG. 10, allowing the user to more distinctly specify the parameters for conducting the search. It can be seen that the parameters include parameters 528 shown in FIG. 7, and additional parameters 602 that indicate that the response was successful. This may be extremely helpful, for example, if a user has a similar type of rejection which was overcome by a response to another office action before the same Examiner. Again, once the parameters are selected, the user simply actuates the submit button 534 and data search system 118 generates the search results, as described above with respect to FIG. 7.

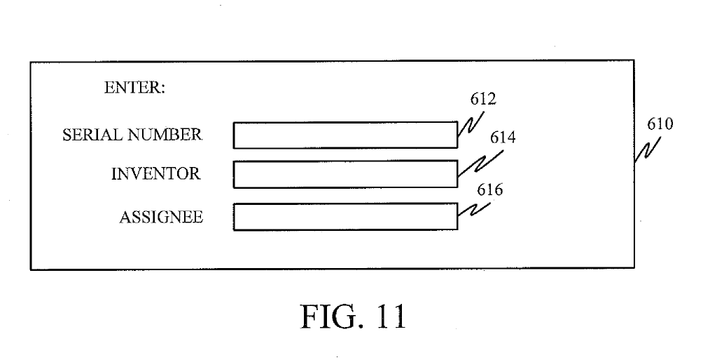

Now assume that in FIG. 2, the user has indicated a desire to search information about a specific serial number, inventor, or assignee. System 108 will illustratively provide a user with a user interface, such as user interface 610 shown in FIG. 11. This allows the user to enter the serial number, inventor, or assignee in text boxes 612, 614, or 616, respectively. If the user selects a serial number, data search system 118 illustratively presents a list of documents contained in the file history for that serial number to the user. The user can then simply actuate hyperlinks to the various documents to view whatever document the user desires. If the user enters a specific inventor name, data search system 118 illustratively presents a list of serial numbers and titles, and other summary information, which have the identified inventor as an inventor on the case.

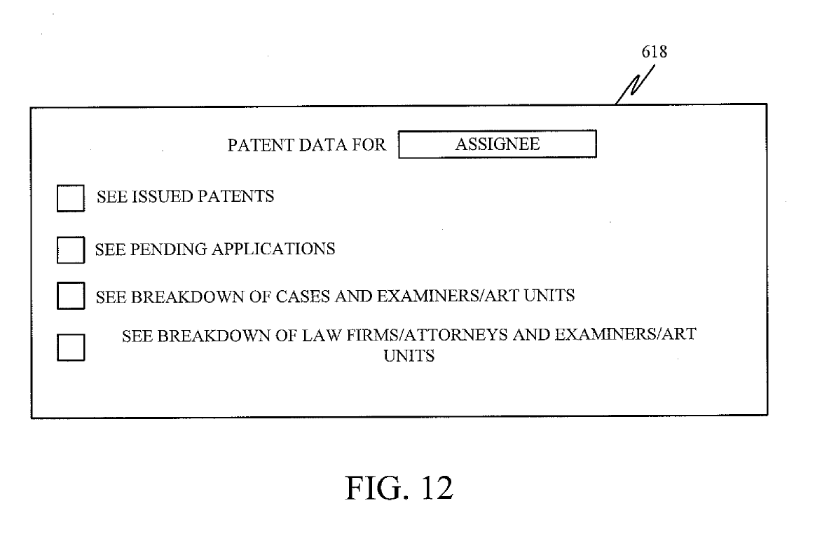

If, however, the user desires to search based on a given assignee, system 108 will illustratively allow the user to more specifically identify the information sought such as by providing a user interface 618 such as that shown in FIG. 12. User interface 618 shown in FIG. 12 allows the user 112 to specify the data sought for a given assignee. This user can simply check the various boxes on user interface 618, such as the issued patents, the pending applications, a breakdown of cases and Examiners in the various art units for the identified assignee, or a breakdown of law firms/attorneys and Examiners or art units for the given assignees.

The first two parameters are fairly straightforward and simply generate a list of issued patents or pending applications with the identified assignee. Assume, however, that the user has chosen a breakdown of cases and Examiners or art units. In that case, data search system 118 will generate queries or execute preformed queries to obtain the necessary information from aggregated Examiner data 106. The data will then be presented back through user interface system 108 as search results 120 in an appropriate search user interface 116, to user 112.

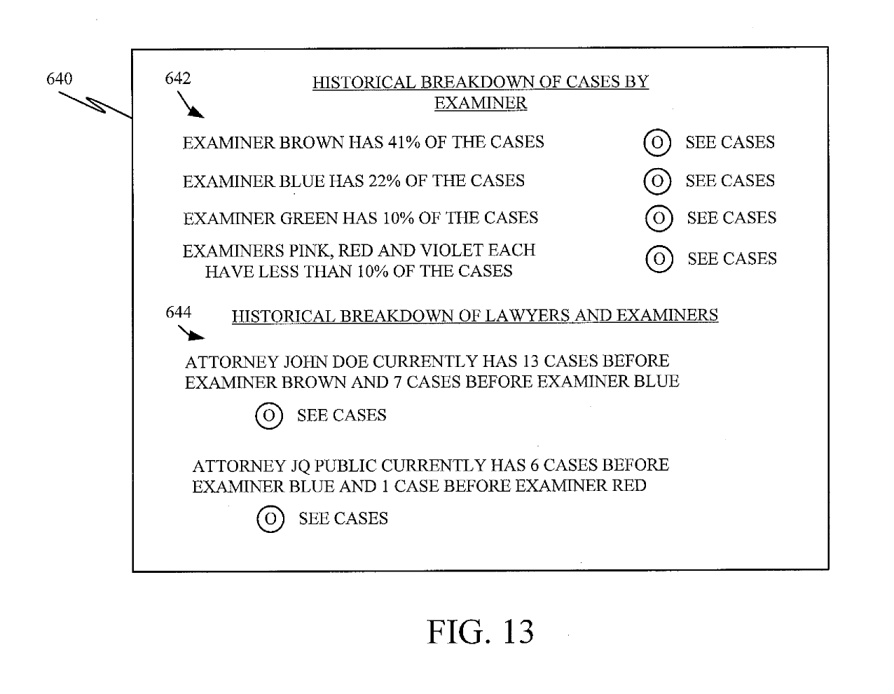

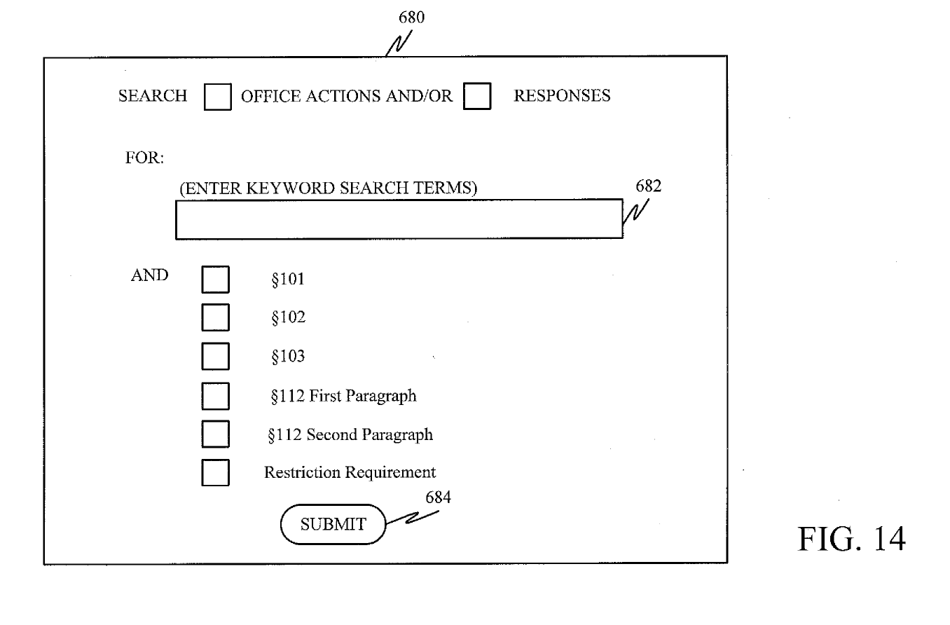

FIG. 13 shows one embodiment of a user interface 640 that can be used to report such results. A user interface 640 includes a top portion which identifies “a historical breakdown of cases by Examiner”. This portion 642 identifies the various Examiners, and the percent of cases for the identified assignee that the Examiner is handling. For instance, user interface 640 shows that Examiner Brown has 41 percent of the cases for this assignee, while Examiner Blue has 22 percent and Examiner Green has 10 percent. User interface 640 also indicates that Examiners Pink, Red and Violet have less than 10 percent of the cases for this assignee. The embodiment of the user interface 640 shown in FIG. 13 also presents radio buttons that can be selected by the user to see a list of hyperlinks to the various cases that each of the Examiners have. Those hyperlinks will illustratively allow the user to pull up the file histories for each of those cases as well.

The bottom portion 644 of user interface 640 identifies a current or historical breakdown of lawyers and Examiners for this assignee. For instance, the breakdown indicates that attorney John Doe currently has 13 cases before Examiner Brown and 7 cases before Examiner Blue. This can be very helpful for a client that desires expeditious prosecution. For instance, by identifying which attorneys have the most cases with a given Examiner, where a client uses a variety of different patent attorneys to obtain its patents, the client can identify which attorneys have the most cases before the various Examiners. It can be very helpful to develop a personal rapport with patent Examiners. Therefore, by aggregating all cases before a given Examiner with one, or a small group of, attorneys, those attorneys may have better success in prosecuting the patents, because they have come to know the Examiner better.

FIG. 13 also shows that attorney JQ Public currently has 6 cases before Examiner Blue and 1 case before Examiner Red. Again, radio buttons are provided so that the user can see the specific cases being handled by those attorneys, before the identified Examiners.

Now assume that, in FIG. 2, the user has made a selection indicating that the user desires to perform keyword searching. In that case, search user interface system 108 illustratively generates a user interface, such as user interface 680 shown in FIG. 14, which allows the user to enter the keywords and various other parameters that the user desires for searching. The embodiment shown in FIG. 14 shows that user interface 680 allows the user to select searching of office actions and/or responses, simply by selecting the appropriate boxes, and then allows the user to enter keywords into field 682. The embodiment shown in FIG. 14 also allows the user to select additional parameters, such as statutory sections addressed by the office actions or responses, such as limiting the office actions or responses to those which were eventually overcome by the applicant, identify those office actions which identify restriction requirements, etc. Once the desired parameters are selected, and the desired keywords are entered into field 682, the user simply needs to actuate the submit button 684. This causes data search system 118 to generate a new query, or execute a preformed query, based on the parameters and keywords identified in user interface 680. Similarly, where PTO interface 126 provides all the necessary search functionality for keyword searching, the user may simply be directed to PTO interface 126 to conduct searching.

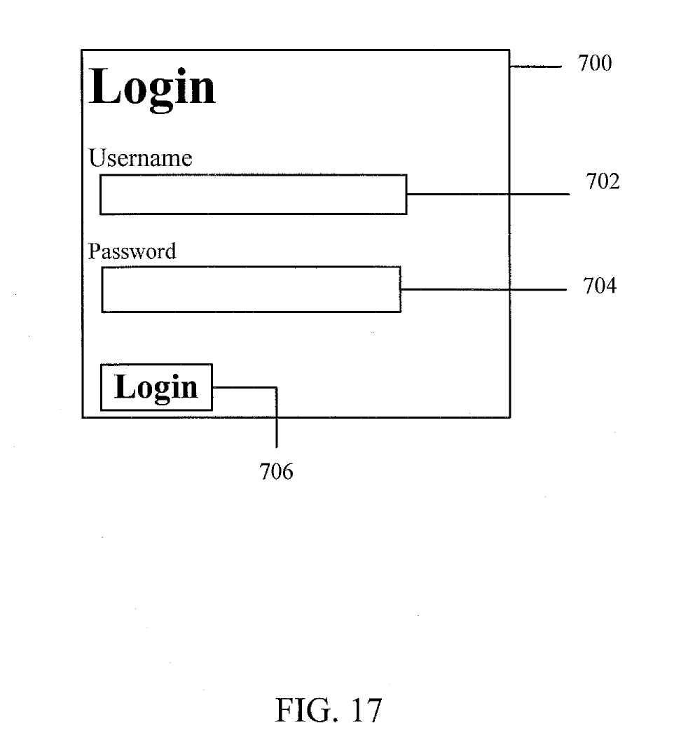

A number of screenshots will now be described to better illustrate the functionality of the system. Of course, it should be noted that these screenshots are exemplary only and additional screenshots, or different screenshots could be generated as well. In any case, FIG. 17 shows one embodiment of a login screen in which a user interface display 700 includes a username text entry box 702 and a password text entry box 704, along with a login button 706. In order to log into the system, a user illustratively enters a username in box 702 and a password in box 704 and presses the login button 706. In one embodiment, the user is given (or selects) the username and password during the subscription process.

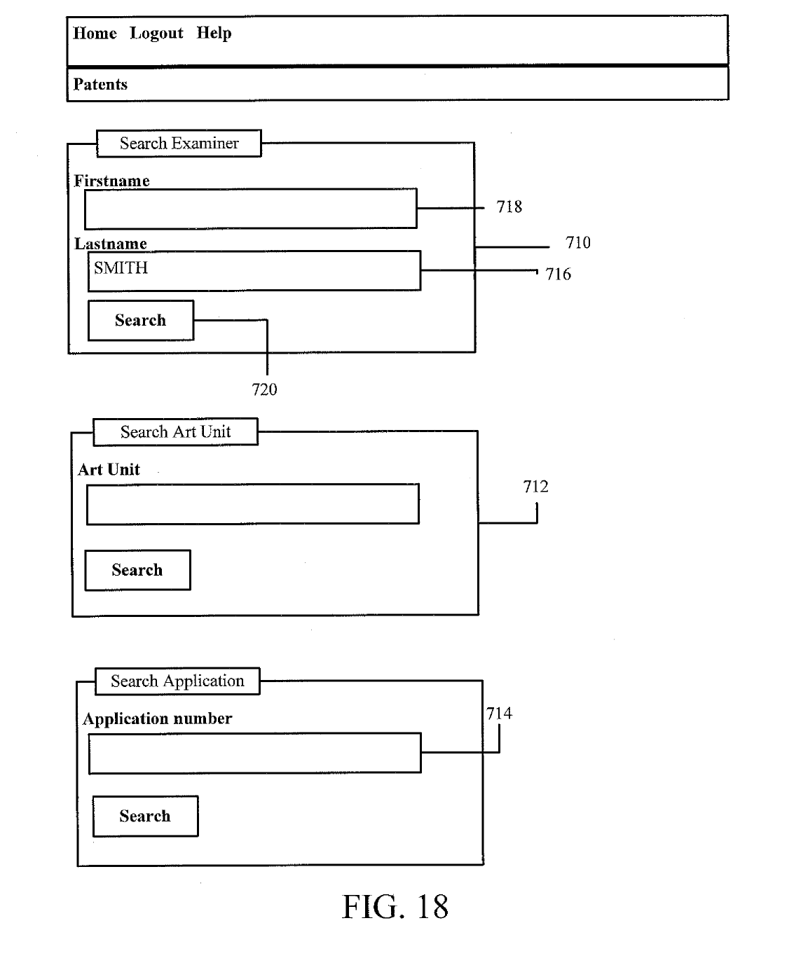

When the user name and password are entered, in accordance with one embodiment, the system generates a user interface display such as that shown, by way of example, in FIG. 18.

FIG. 18 shows that the system generates a display including an Examiner search box 710, an art unit search box 712 and an application number search box 714. While the user can search through an art unit by entering the art unit number in box 712, or pull up a specific application number by entering the application number in box 714, the functionality of Examiner search box 710 will be discussed in greater detail.

In the embodiment shown in FIG. 18, a user has entered the last name “Smith” in a last name box 716. Of course, it will be noted that a first name box 718 can be generated as well, so that a user can enter an Examiner's first name in that box to narrow the search.

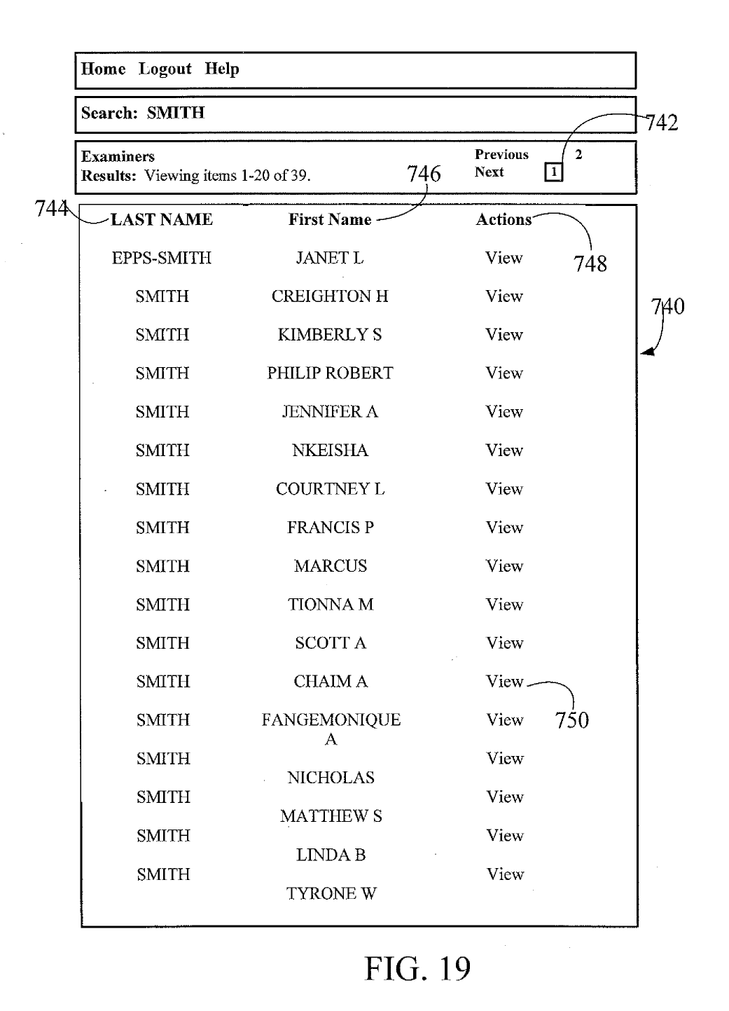

Once a name is entered in one of boxes 716 or 718, the user illustratively actuates the search button 720 to search the Examiner data store. Assuming that the user has entered “Smith” and actuated search button 720, as shown in FIG. 18, an Examiner search results page 740 is illustratively automatically generated, such as that shown in FIG. 19.

It can be seen from FIG. 19 that there are 39 Examiner's in the Examiner data store 104 or 106 that have a last name of “Smith”. Display 740 displays the first 20 of those. A page selector section 742 allows a user to page through multiple pages of results. Of course, it will be appreciated that displaying 20 search results on a single page is exemplary only and more or fewer results could be displayed on a given page.

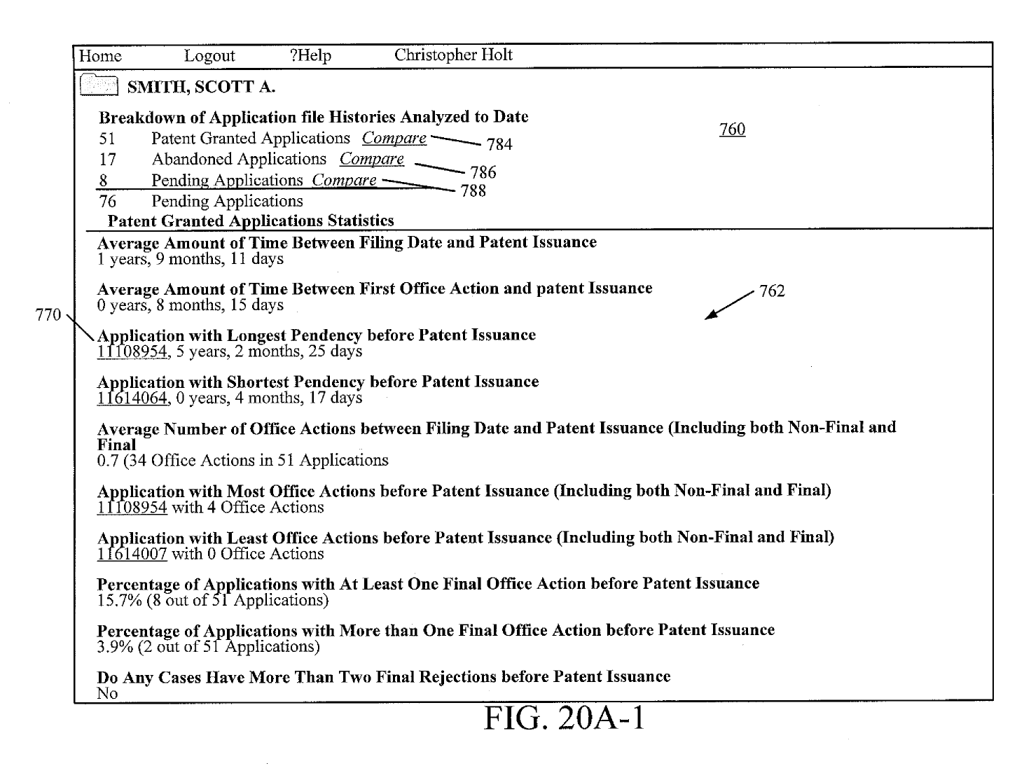

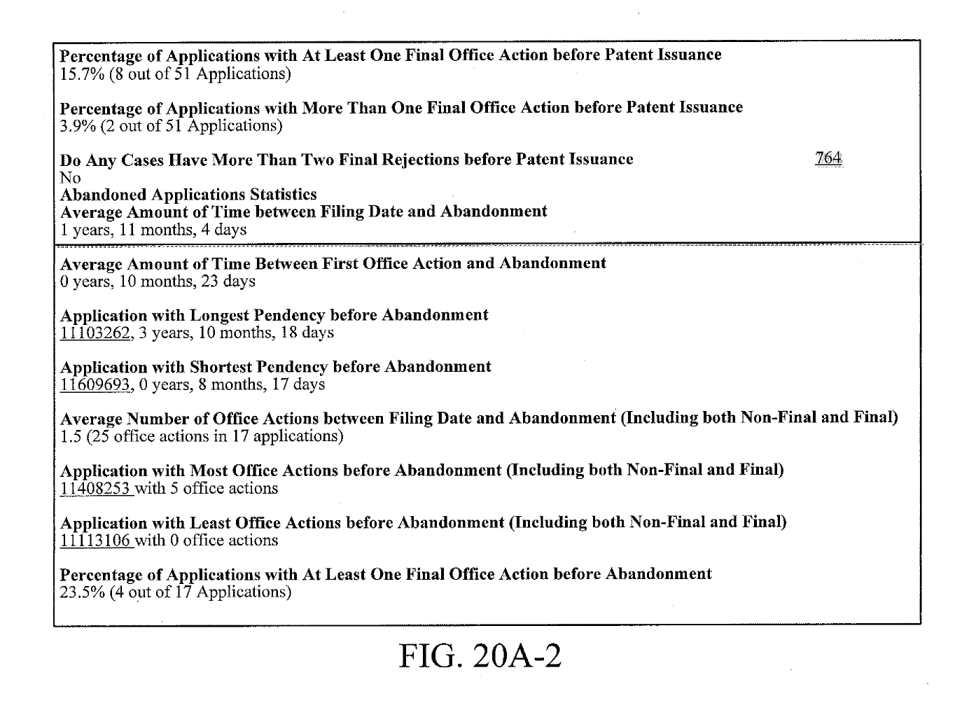

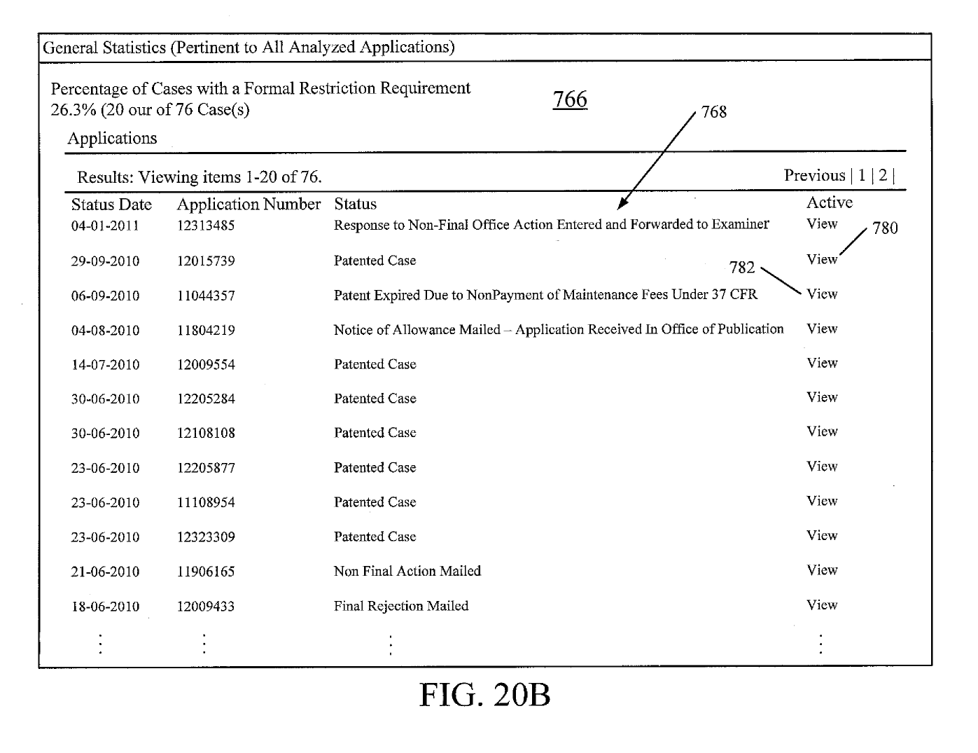

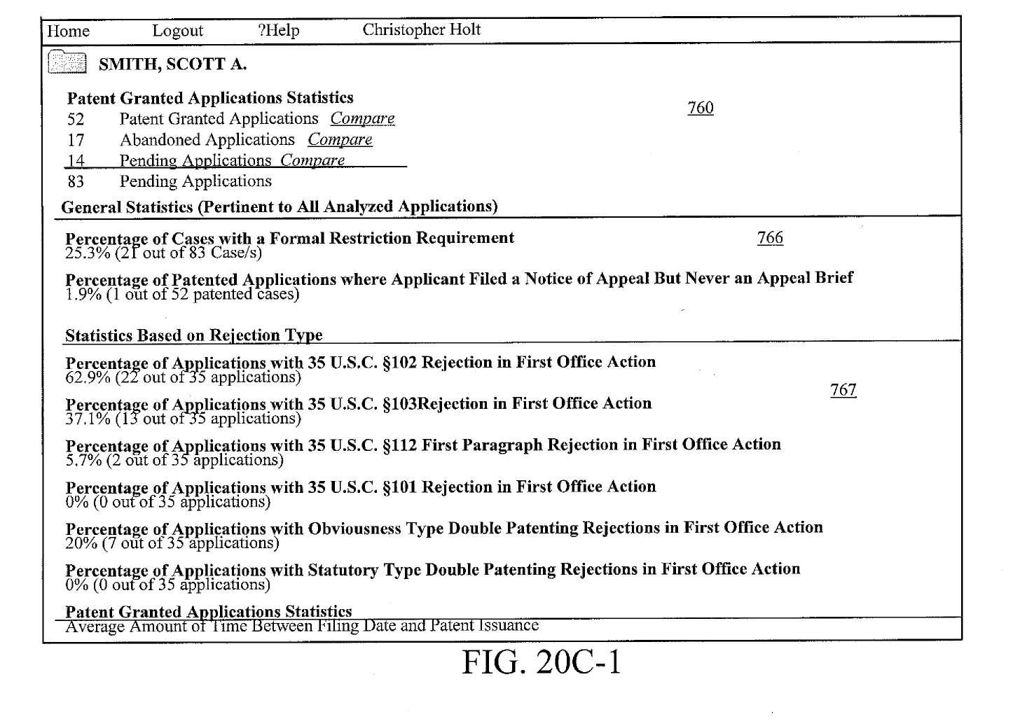

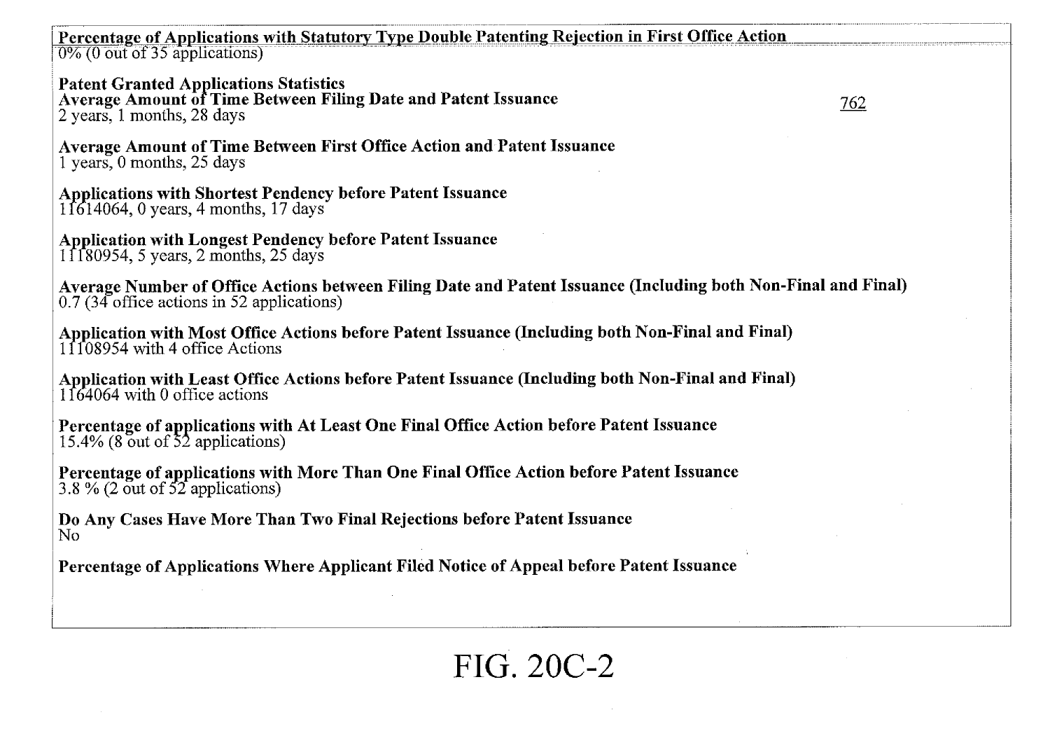

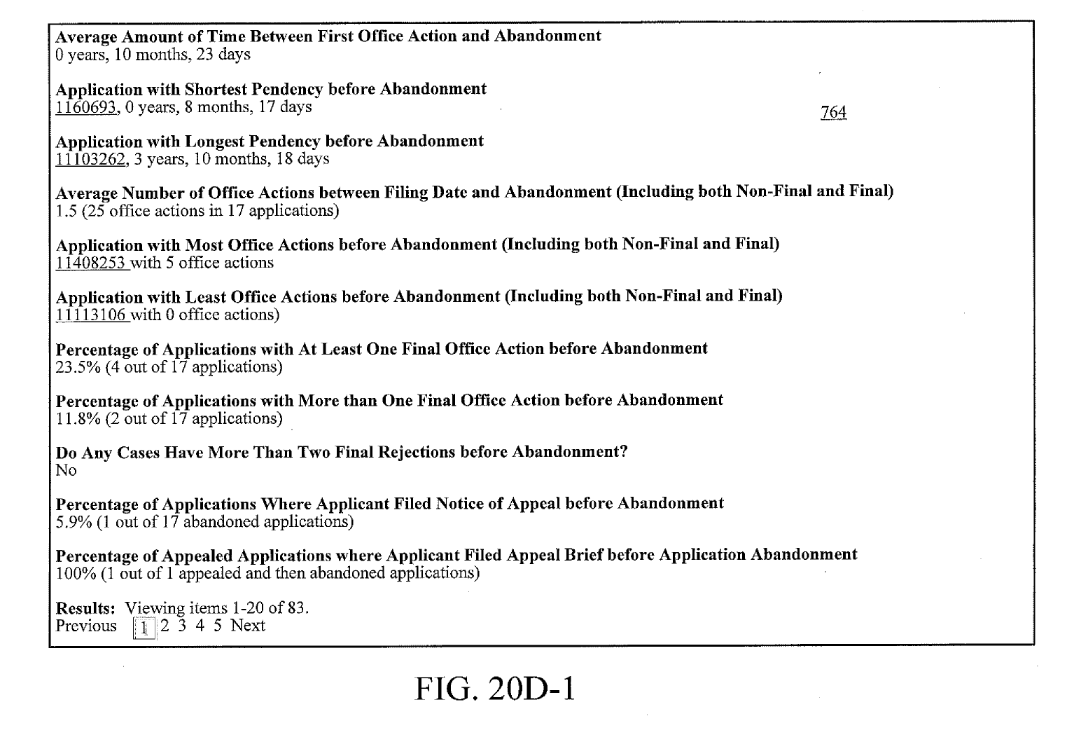

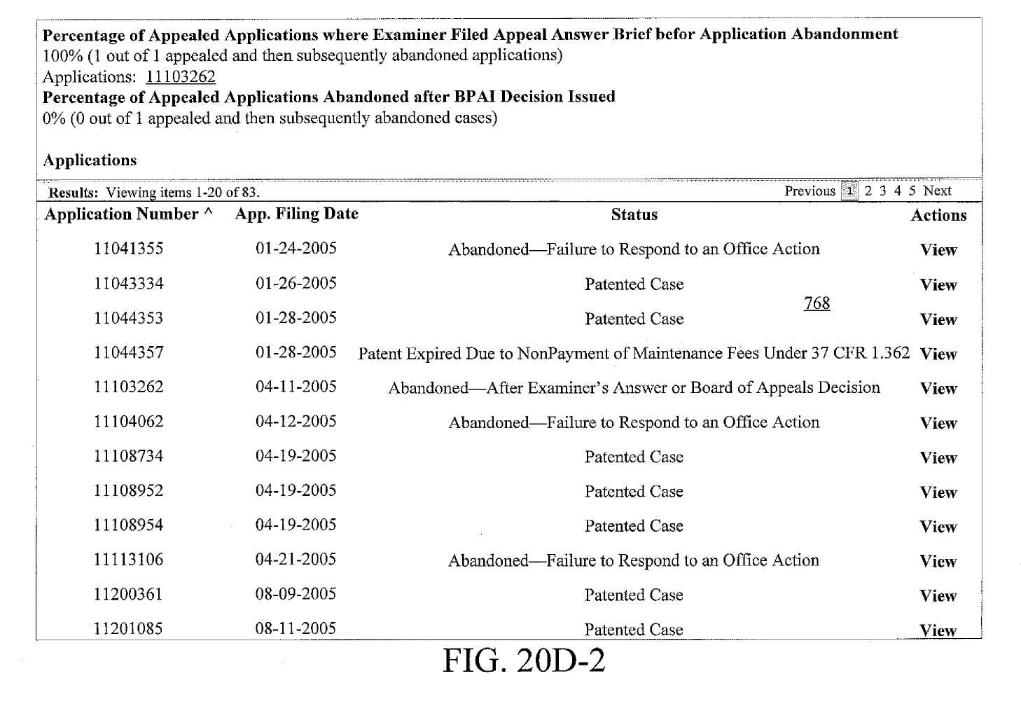

In the embodiment shown in FIG. 19, display 740 includes an Examiner last name column 744, and Examiner first name column 746, and an actions column 748. Actions column 748 includes actuable user interface elements, such as “view” buttons which allow a user to view more specific information associated with one of the Examiners in display 740. For instance, assume that the user actuates the “view” button 750 associated with the Examiner “Scott A. Smith”. In that embodiment, data search system 118 illustratively automatically generates a user interface display such as that shown in FIGS. 20A and 20B. The user interface display shown in FIGS. 20A and 20B includes a plurality of sections which are given for the sake of example only. Different or additional sections could be provided as well. The statistics illustrated and used to support the various selections and displays are illustratively generated by data aggregation system 122 and stored in the data store 106. They can be pre-computed and updated off-line or computed or updated on-the-fly during runtime.

In any case, the display in FIG. 20A includes breakdown section 760 that gives an overall breakdown of the number of applications or cases that are currently stored in the Examiner data store 104 or 106 for the Examiner “Scott A. Smith”. It can be seen from FIG. 20A that section 760 shows that the data store includes data for 51 granted patents, 17 abandoned applications and 8 pending applications, for a total of 78 applications.

The exemplary user interface shown in FIGS. 20A and 20B also includes a patent granted statistics section 762, an abandoned application statistics section 764, a general statistics section 766, and a specific applications section 768. The patent granted statistics section 762 illustratively includes a plurality of useful statistics that correspond to the granted patent applications for Examiner “Scott A. Smith” in the Examiner data store 104 or 106. It can be seen from FIG. 20A that the illustrative statistics in section 762 include the average amount of time between filing date and patent issuance, the average amount of time between a first Office Action and issuance, an identification of the specific application with the longest pendency before patent issuance, and identification of the specific application with the shortest pendency before patent issuance, an average number of Office Actions between the filing date and patent issuance, an identification of the specific application with the most Office Actions before patent issuance, an identification of the application with the least Office Actions before patent issuance, a percent of applications with at least one final Office Action before patent issuance, a percent of applications with more than one final Office Action before patent issuance, and an indication as to whether any case has more than two final rejections before patent issuance.

Some or all of the statistics shown in section 762 can be useful in identifying the characteristics and nature of the Patent Examiner who is currently the subject of the search. For instance, if a particular Patent Applicant has a patent application that is dragging on for many years, and through many final rejections, the Patent Applicant can pull up these statistics for the Examiner working on the case to determine whether their case is unusual for that Examiner. This can help the client or Patent Attorney determine whether an interview may be helpful or whether the Patent Applicant might choose some other strategy in presenting his or her case to the Patent Examiner. In addition, the Patent Applicant may find that this is a normal prosecution for this specific Patent Examiner. In any case, the information is helpful in moving the case to a more quick resolution, and it may also be helpful for a patent attorney to manage a client's expectations. If the client knows that the extended prosecution is normal for this given Examiner, that may help set expectations. On the other hand, if the Examiner is efficient and has relatively quick prosecutions, then the client may know that something is unusual either with the Patent Attorney or the Patent Examiner, or both. In any case, this information would be helpful to identify that the application is somehow off track in its prosecution.

In addition, those statistics shown in FIGS. 20A and 20B which identify a specific application illustratively have actuable links to the application. For instance, link 770 links to a specific serial number that is the application for this Patent Examiner with the longest pendency before patent issuance. This may help a Patent Attorney or Applicant to identify certain problems that cause the pendency of the application to be extended. This can help to eliminate those types of issues and expedite prosecution.

FIG. 20A shows that section 764 includes some similar statistics and similar links to identified applications, but for applications that this Examiner has worked on that have been abandoned. Again, a Patent Attorney or Patent Applicant may examine these cases to identify strategies that have not worked with this Examiner, or that have caused undue delay or an extensive amount of Office Actions, and avoid those strategies or arguments. Instead, the Patent Attorney or Applicant can focus on strategies and arguments identified in the cases shown in section 762 that tend to expedite prosecution, making both the client and the Patent Examiner happier and more efficient.

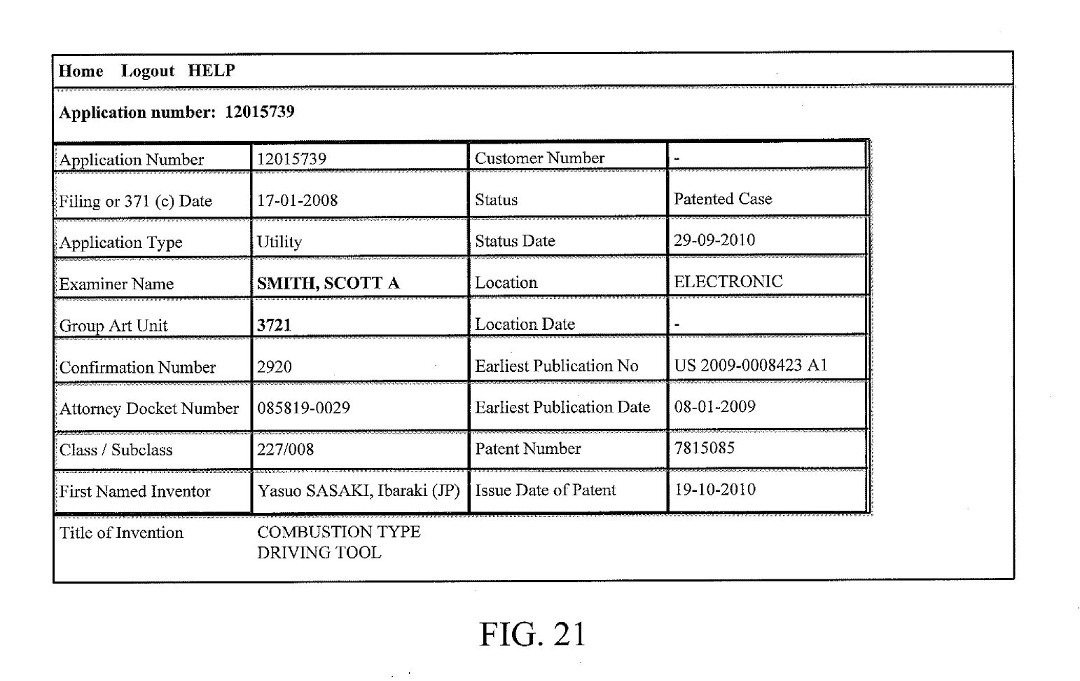

Section 768 actually lists the applications included in generating the statics and identifies them by status date (date of the last status update for this case), application number, and status. Of course, these columns can be different or more columns can be added as well. For instance, a filing date column can be added or it can replace the status date column. Also, the column headings can be actuable buttons which, when clicked, re-arrange the results. For instance, if the “Status Date” button is clicked, it can arrange the results in ascending or descending order by status date. Similarly, where the “Application Number” button is clicked, it can re-arrange the results sequentially according to application number. In addition, each entry includes an actuable link 780 which, when actuated by the user, allows the user to jump to the specific file history record for that serial number. For instance, assume a user of the system viewing FIG. 20B clicks on, or actuates, “view” button 782. In that instance, the system illustratively automatically generates a user interface display such as that shown in FIG. 21. FIG. 21 gives a great deal of additional information about that specific patent application. In addition, it should be noted that by actuating button 782, in one embodiment, the user may jump to a record of the actual file history which can be viewed. The display shown in FIG. 21 is exemplary only.

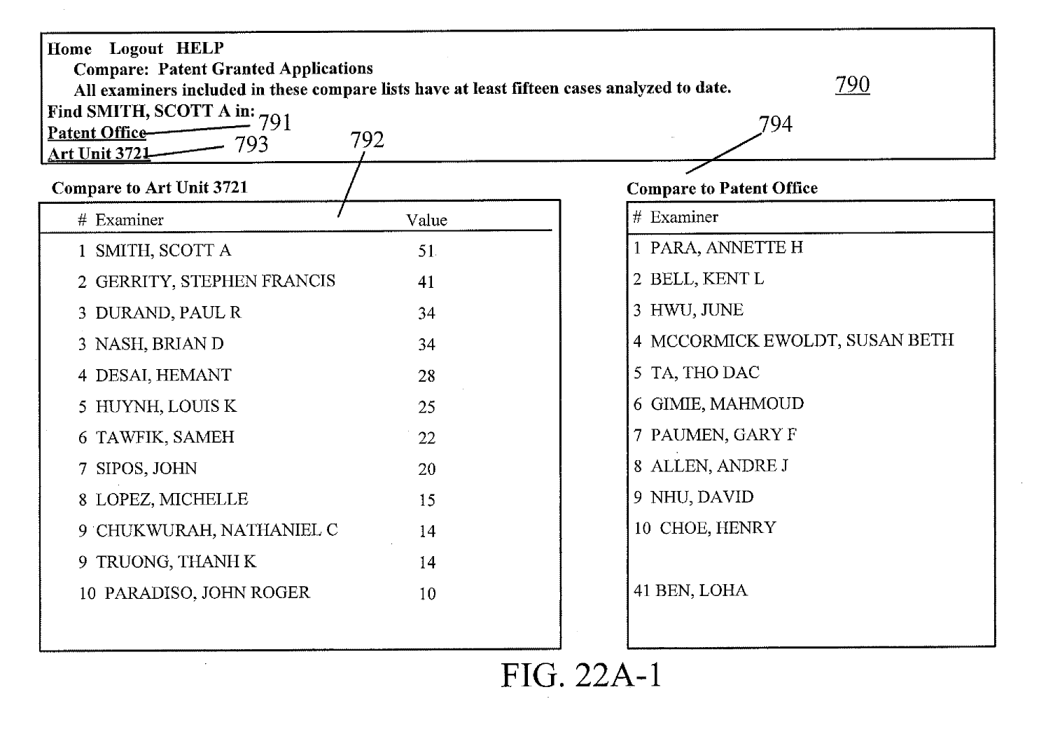

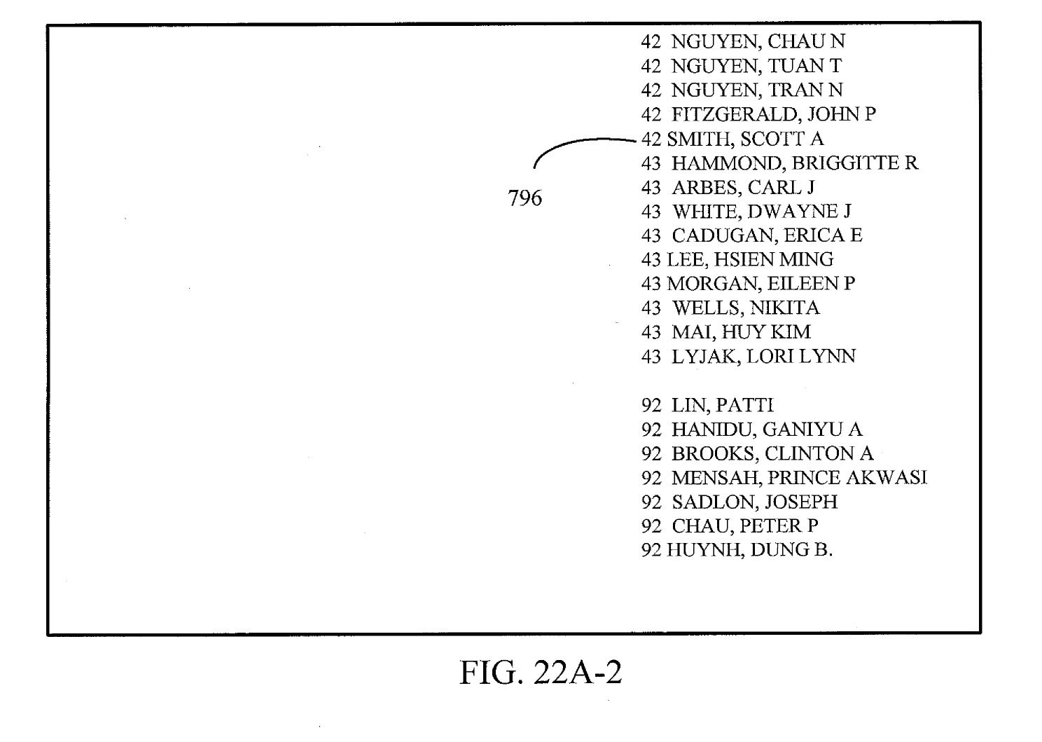

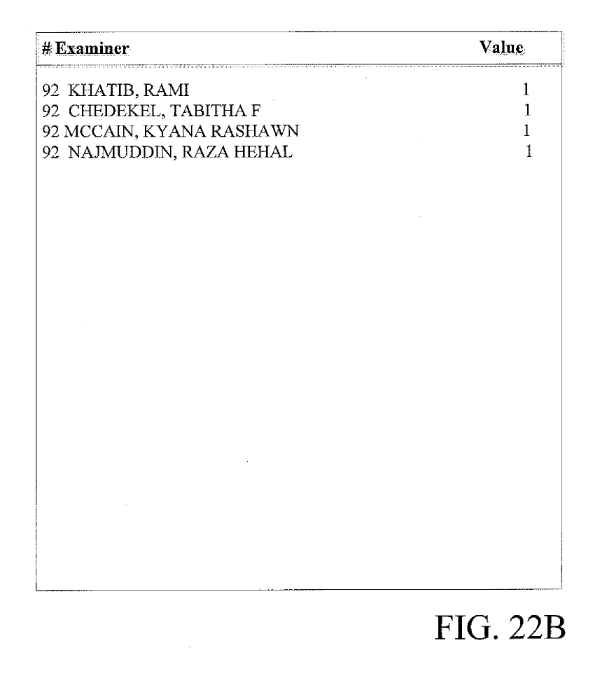

Referring again to FIG. 20A, breakdown section 760 also includes a number of “Compare” buttons 784, 786, and 788. If the user actuates one of those buttons, then the system illustratively generates a user interface display such as that shown in FIGS. 22A and 22B. For instance, assume that the user has actuated the Compare button 784. This automatically generates the screenshot shown in FIG. 22A which compares the Examiner under analyses (Scott A. Smith) against other Examiners in that Examiner's art unit and against other Examiners across the entire Patent Office.

The display shown in FIGS. 22A and 22B includes an identification section 790 which identifies the Examiner and includes links 791 and 793 to comparison sections 792 and 794. When the user actuates link 791, then the display shows section 794 which compares the Examiner against all Examiners in the Patent Office, for which the system has an adequate number of statistics. Keep in mind that the current Patent Examiner (Scott A. Smith) is being compared for “patent granted applications”, because the user actuated compare button 784 in FIG. 20B. If, on the other hand, the user had actuated button 786, then Scott A. Smith would be compared against the other Examiners in the Patent Office for “abandoned applications”, and if the user had actuated Compare button 788, then Scott A. Smith would be compared against other Patent Examiners in the Patent Office for “pending applications.” In any case, it can be seen that Scott A. Smith ranks 42nd (as shown by field 796) against all other Examiners for which the system has an adequate number of statistics.

If, in section 790, the user actuates art unit button 793, then the system automatically generates a display that shows section 792 which compares this Examiner against all other Examiners in the same art unit, for which the system has adequate statistics.

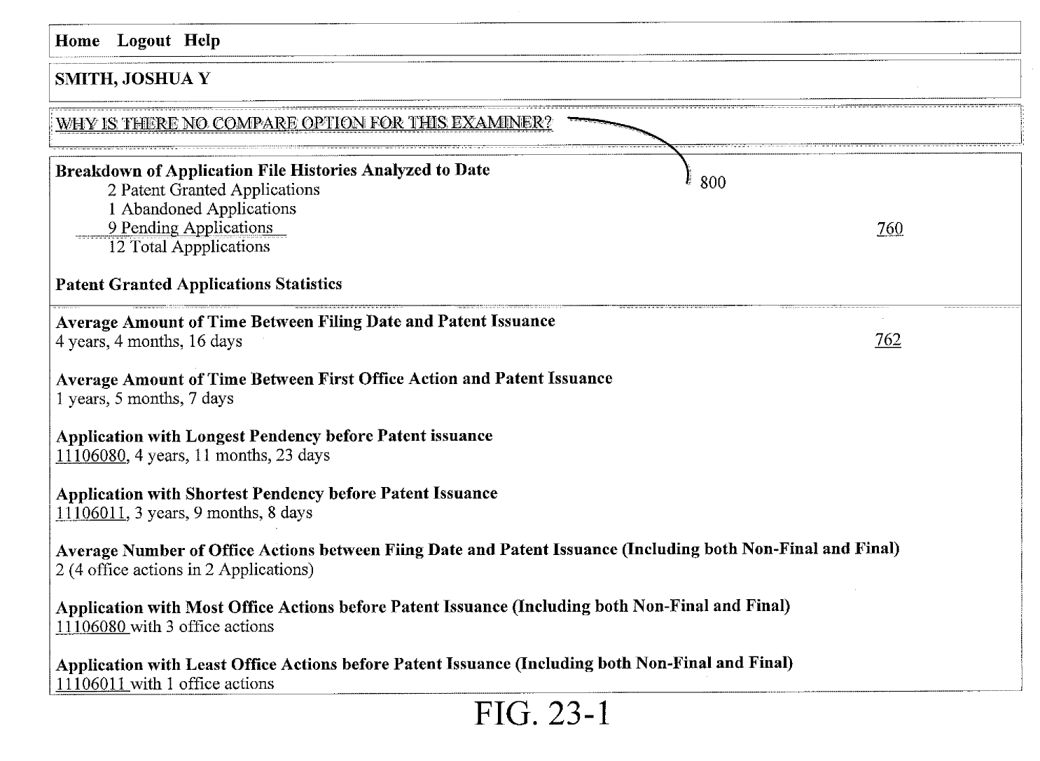

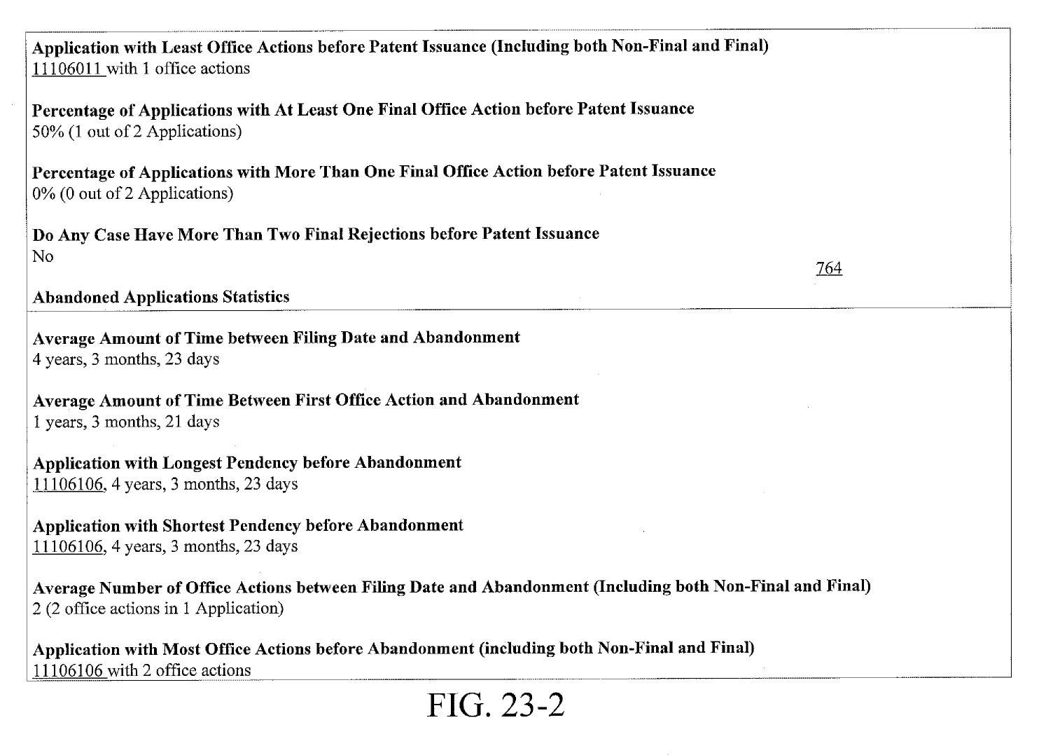

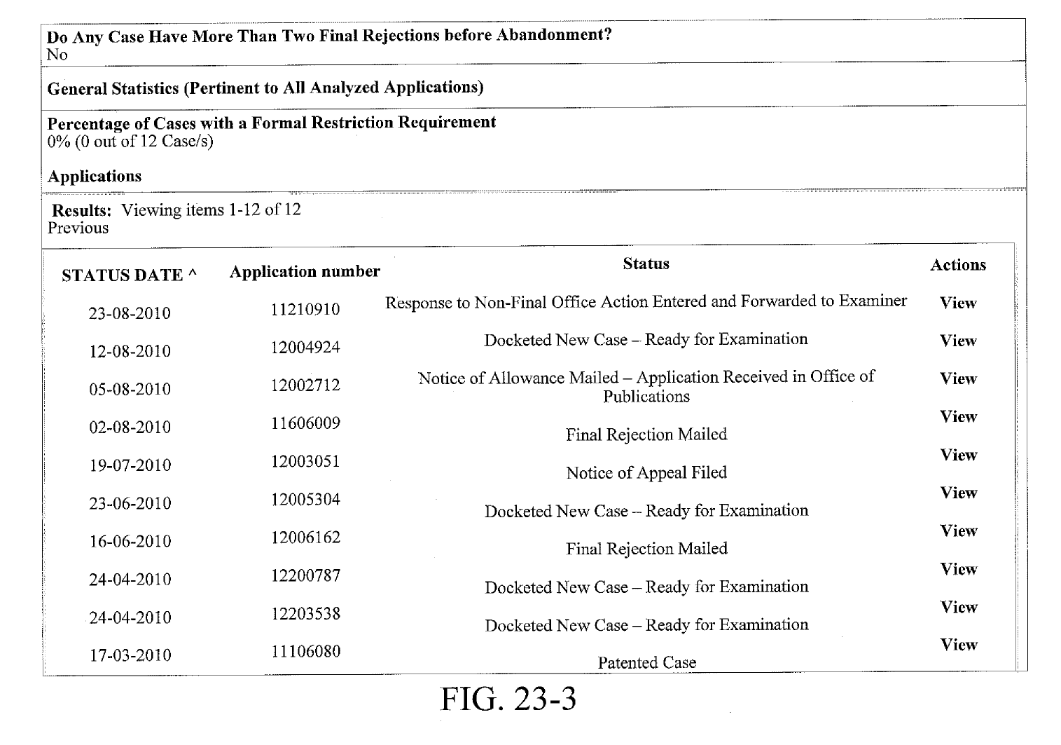

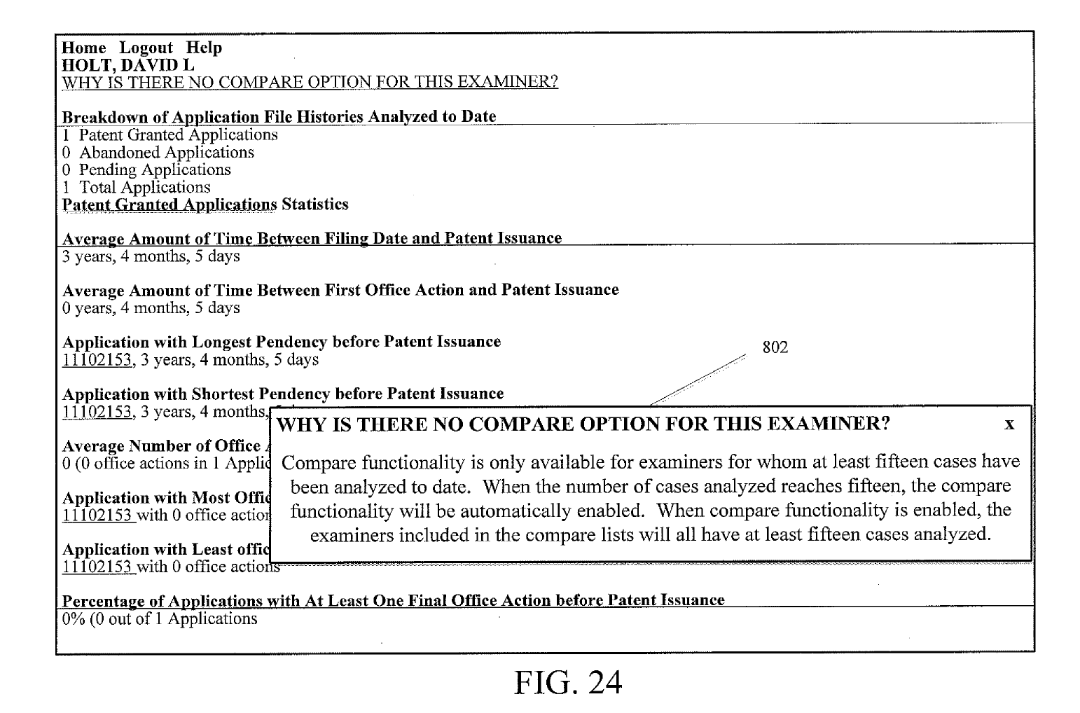

It should be noted that, in one illustrative embodiment, Examiners are only compared against one another if there is a sufficient number of statistics for the Examiners included in the comparison. For instance, if an Examiner has just started working, or if for any other reason the system does not have an adequate number of statistics for a given Examiner, then that Examiner will not be included in the comparison, because there are not enough statistics to accurately reflect the Examiner's performance. When that is the case, in accordance with one embodiment, section 760 in FIG. 20A either does not include Compare buttons 784, 786 and 788, or those buttons are “grayed out” or otherwise visually indicated as being inoperable. For instance, FIG. 23 shows a display similar to that shown in FIG. 20A, and similar sections are similarly numbered. It can be seen, however, that section 760 does not include any Compare buttons. Instead, section 760 has a button, such as button 800, which includes some type of indication that there are insufficient statistics for this Examiner. For example, button 800 shown in section 760 of FIG. 23 states “Why is there no compare option for this Examiner?” If the user activates that link, or button, then the system generates a display such as that shown in FIG. 24. In essence, the system pops-up a display 802 explaining that the compare functionality is only available for Examiners for whom at least a given number (such as 15) cases have been analyzed. Of course, the given number can be any desired number, and this is only one way of letting the user know why there is no compare functionality associated with the given Examiner. Other ways can be used as well.

FIGS. 20C and 20D show another embodiment of user interface displays. They are similar to FIGS. 20A and 20B and similar items are similarly numbered. FIG. 20C also includes section 767 that shows statistics that are broken out by rejection type and statutory section. FIGS. 20C and 20D also show statistics related to appeal. In addition, the columns in section 768 of FIG. 20D are different from those in FIG. 20B.

It will be appreciated that a wide variety of different user interface configurations can be used in the present system. Those shown are for exemplary purposes only. Appendix F includes a list identifying other types of user interface elements, and the items which they can be illustratively used for. Although this list is not even exhaustive, of course,

It will also be noted that the results can be used in a wide variety of different ways. Similarly, the various searches that can be conducted using the present system need not be limited to those shown and discussed here, but the searches can be substantially any searches desired in aggregated Examiner data 106. Those listed are exemplary only.

In another embodiment, examiner information accessing system 102 illustratively allows users to search for, and be provided, statistical information corresponding to the specific user. For instance, in one embodiment, user 112 is a member of an enterprise, such as a corporation, an academic institution or other organization. In that embodiment, search user interface system 108 presents a user-specific user interface that can be used by user 112, based upon the enterprise or organization that user 112 belongs to.

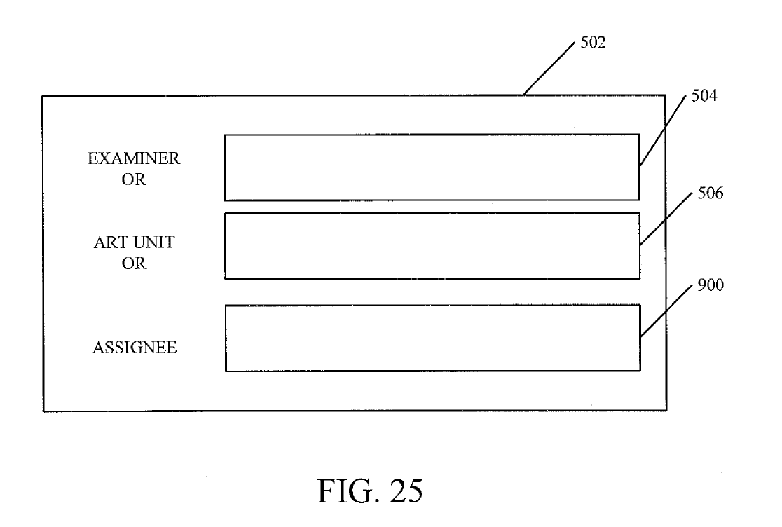

FIG. 25 is another embodiment of a search interface that can be used by a user 112 to search for information. The embodiment shown in FIG. 25 is similar to embodiments shown in FIG. 3 except that the user interface 502 not only includes an examiner's name search box 504 and an art unit search box 506, but it also includes an assignee search box 900. Thus, in one embodiment, the user can enter an assignee in box 900 and search user interface system 108 interacts with examiner information accessing system 102 to retrieve the statistics described above, but focused on a given assignee.

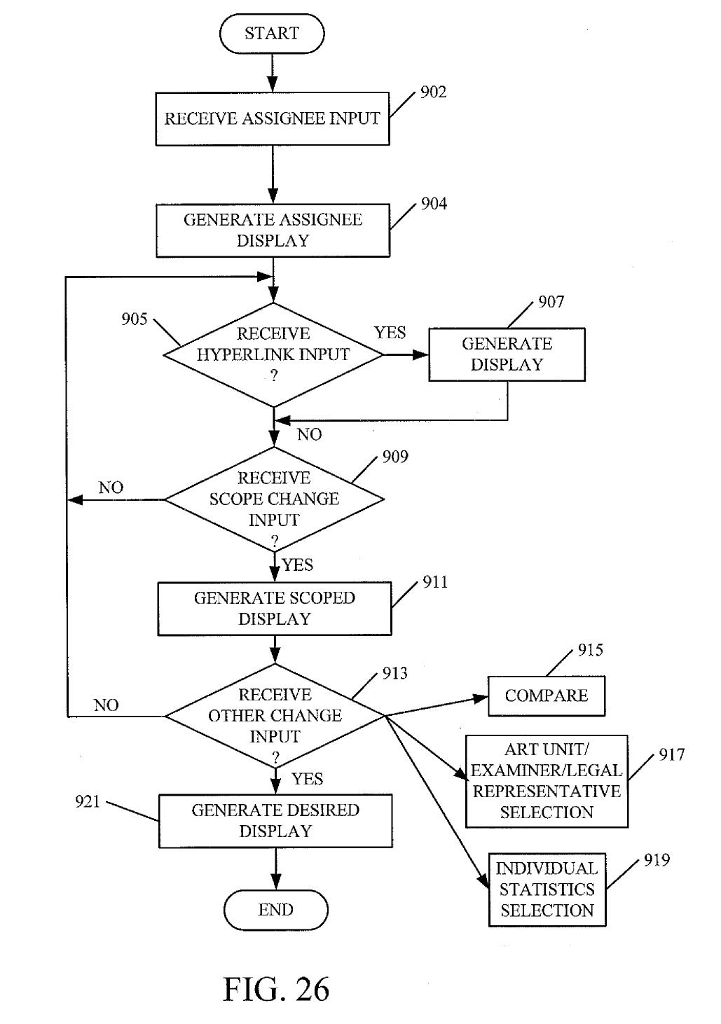

FIG. 26 is a flow diagram illustrating one embodiment of the operation of the system 100 in generating assignee search results for a corporate dashboard view of the data. User interface system 108 first receives an assignee input in box 900 from a user. This is indicated by block 902 in FIG. 26. If there are records for more than one assignee having a similar name, they can all be displayed in a disambiguation user interface that allows user 112 to select the desired assignee. In one embodiment, the disambiguation user interface illustratively lists the name of each assignee along with the number of records corresponding to each assignee. The user 112 selects one assignee from the list.

System 108 then uses system 102 to access examiner data and, in one embodiment, returns the statistics discussed above with respect to FIGS. 20A-20D and 23, for all examiners and art units for patent applications assigned to the given assignee input by, or selected by, user 112. The system then generates an assignee display, as indicated by block 904 in FIG. 26.

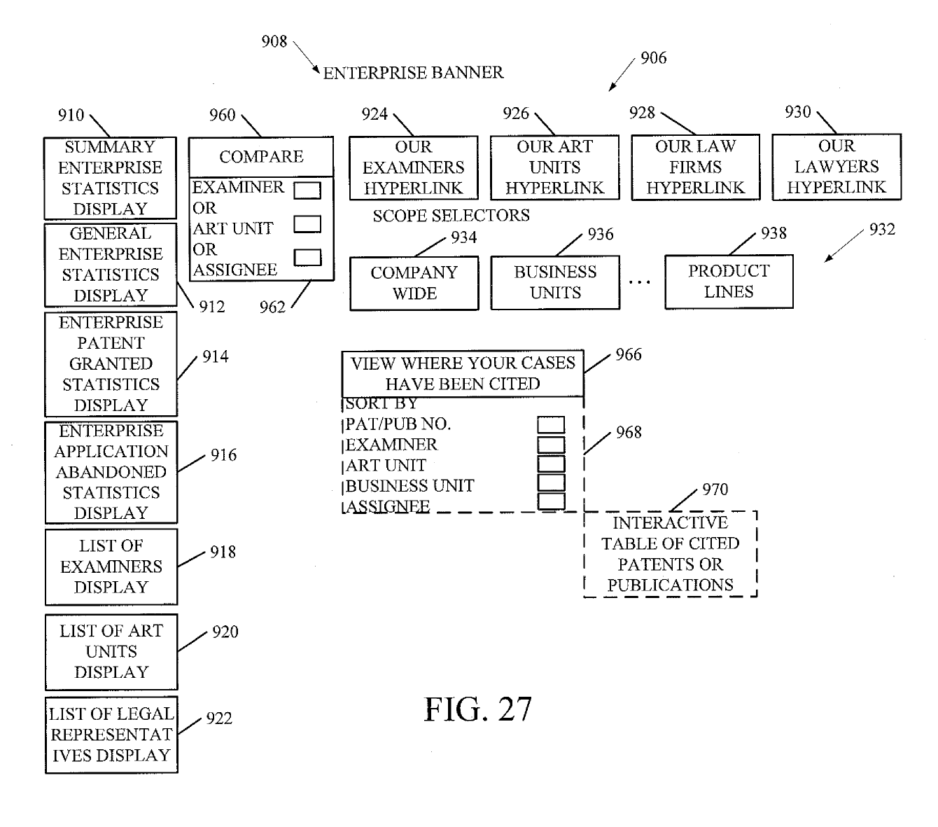

FIG. 27 shows one embodiment of the layout of an assignee display 906. Assignee display 906 can also illustratively be referred to as a corporation dashboard, an enterprise dashboard, or the like. In the embodiment shown in FIG. 27, enterprise dashboard 906 includes an enterprise banner section 908 which illustratively includes the name of the enterprise or organization for which the statistics are generated. Dashboard 906 also illustratively includes a display portion that displays summary statistics for the enterprise. This is indicated by block 910 in FIG. 7. Dashboard 906 also illustratively includes a display portion that displays general statistics for the enterprise, as indicated at block 912, patent granted statistics for the enterprise indicated by block 914, application abandoned statistics as indicated by block 916, a list of examiners that have examined applications for the enterprise as indicated by block 918, a list of art units in which the patents and applications for the enterprise are examined as indicated by block 920, and a list of a legal representatives that are handling, or have handled, patent applications for the enterprise, as indicated by block 922.

Dashboard 906 also illustratively includes hyperlinks 924, 926, 928 and 930 that allow a user, when they select or actuate the given hyperlink, to immediately jump to a corresponding place on dashboard 906. For instance, when a user actuates hyperlink 924, the user jumps to the list of examiners portion 918 of dashboard 906. When the user actuates the art unit hyperlink 926, the user jumps to the list of art units portion 920 of dashboard 906. When the user actuates the law firms hyperlink or the lawyers hyperlink 930, the user jumps to legal representatives display portion 922 of dashboard 906. Hyperlinks 924-930 thus enable easy navigation through dashboard 906. These hyperlinks are illustrative, and others can be used as well. Receiving a hyperlink input and jumping to the proper portion of dashboard 906 is indicated by blocks 905 and 907 in FIG. 26.

In one embodiment, dashboard 906 also displays actuable scope selectors 932. Scope selectors 932 are illustratively user input mechanisms which allow a user to scope the data used in generating the statistics in the various display portions of dashboard 906. For instance, FIG. 27 shows three scope selectors, including company wide scope selector 934, business unit scope selector 936 and product lines scope selector 938. Therefore, when the user selects company wide scope selector 934, then the information displayed on banner 906 is scoped by the data that corresponds to the enterprise, or company, as a whole. That is, the summary statistics, general statistics, patent granted statistics, application abandoned statistics, examiners, art units, and legal representatives will be all those used by the enterprise or company represented by scope selector 934.

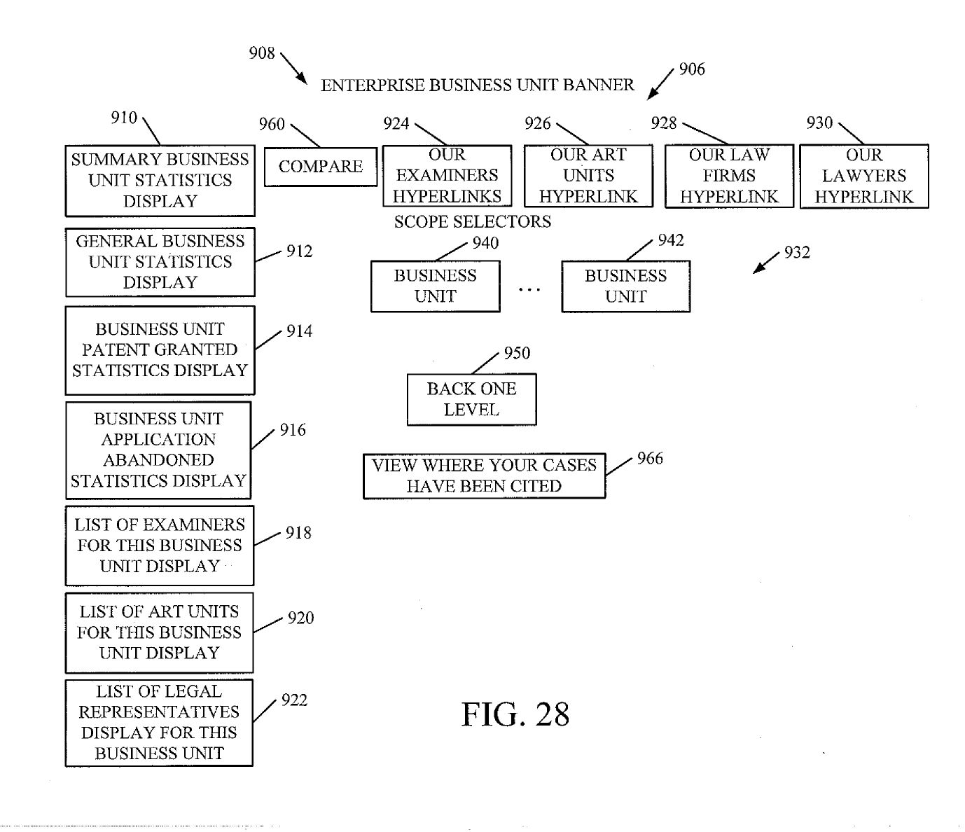

On the other hand, if the user actuates one of the other scope selectors, such as business units scope selector 936 or product lines scope selector 938, then system 100 generates and displays all of the statistics discussed above, but scoped by the selected scope selector. For instance, if the user actuates business units scope selector 936, then system 100 will illustratively generate modified dashboard 906 so that it appears as illustrated in FIG. 28. In FIG. 28, dashboard 906 is generated with the banner portion 908 modified so that it is specific to a selected business unit of the enterprise.

In one embodiment, the scope selectors 932 are also modified so that they list each of the individual business units of the enterprise, as indicated by blocks 940 and 942. Therefore, the user can select one of the given business units of the enterprise, and all of the information and statistics generated on dashboard 906 based on the information that is specific to the selected business unit. Of course, it should be noted that in one embodiment, when the user selects business unit scope selector 936 on the display of FIG. 27, then the user can, at that point, be given the option to choose one of the specific business units of the enterprise (such as through a drop down menu or otherwise), and select that business unit, at that time. Then, as shown in FIG. 28, dashboard 906 will be generated for the selected business unit. Alternatively, as shown in FIG. 28, scope selectors 932 can be presented to the user on the dashboard 906 shown in FIG. 28, and the user can be allowed to select a given business unit from that display. In either case, once the user has selected the business unit scope selector 936, and identified a specific business unit to scope the data (such as business unit selector 940 or business unit selector 942), then the dashboard 906 is generated with information specific to the selected business unit.

It will be noted that the scoped statistics can be generated entirely on-the-fly, once the user 112 actuates a scope selector. Of course, the statistics can also be pre-computed off line, and only updated when the user actuates the scope selector, or they can be pre-computed and updated off line and just displayed when user 112 actuates the scope selector.

As shown in FIG. 28, the summary statistics are now specific to the business units in display portion 910, the general statistics are specific to the selected business unit as shown in block 912, the patent granted statistics are for technology related to the selected business unit at block 914, the application abandoned statistics are for applications that were filed by the business unit, as indicated by block 916, the list of patent examiners are those examiners that are examining or have examined applications filed by this business unit, as indicated by block 918, the art units are the art units where the applications for this business unit are being examined or have been examined, as indicated by block 920, and the list of legal representatives displayed at 922 are those legal representatives (such as law firms or lawyers, or both) which are handling the patent applications for this business unit.

FIG. 28 also illustratively includes a back button or user input mechanism 950 that allows the user to return to the previous scope level. For instance, if the display in FIG. 28 is shown, and the user actuates back button 950, then the display will illustratively return to the enterprise or companywide display as shown in FIG. 27.

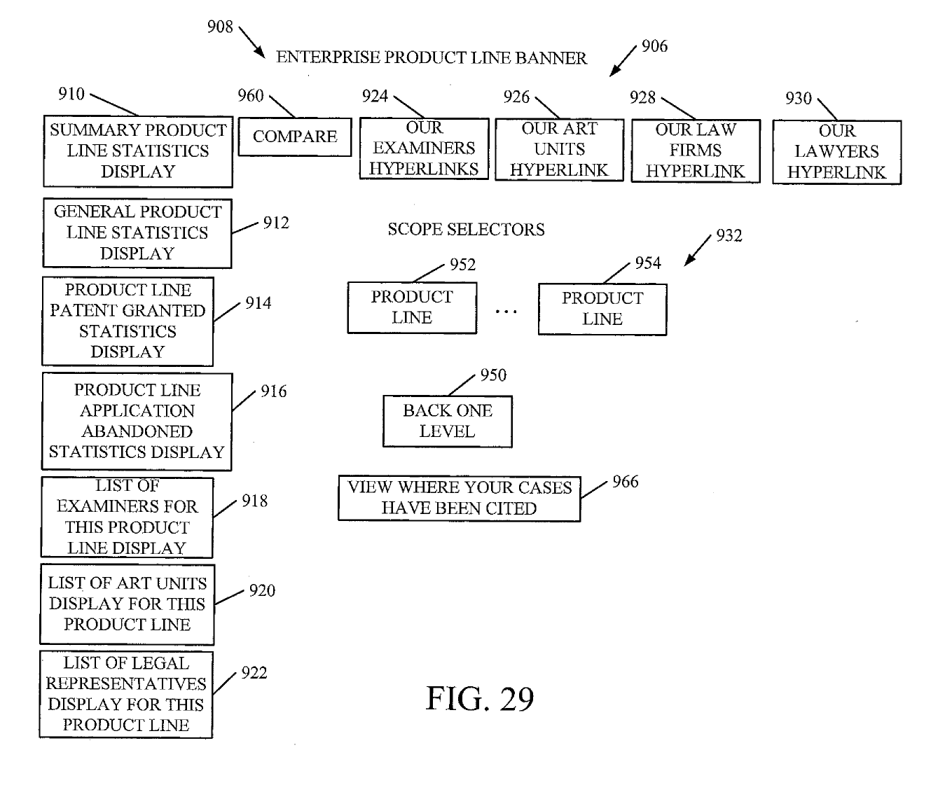

Referring again to FIG. 27, the user may also actuate the product lines scope selector 938. In that case, the system illustratively generates a display such as that shown in FIG. 29. As with the display shown in FIG. 28, it should also be noted that the user can be allowed, from FIG. 27, to select a particular product line to be displayed. Alternatively, the display of FIG. 29 can include product line selectors 952 and 954 as the scope selectors 932, and the user can select a product line from the display shown in FIG. 29 as well.

In either case, the system illustratively modifies dashboard 906 so that the information displayed thereon includes statistics that are related to the selected product line. That is, the enterprise may own a number of patent applications that are filed for various products in different product lines offered by the company. If that is the case, and the user scopes the data by one of those product lines, then all of the display portions 910-922 will illustratively be specific to the applications that are drafted to cover the products in the selected product line.

It should be noted that business units and product lines are only two exemplary scope selectors and others could be used as well. For instance, dashboard 906 may allow a user to scope the data displayed based on an individual product, by a group of business units, by management role (e.g., all units that report to a given manager) or in any other desired way. Receiving a scope change input by selection of one of scope selectors 932, and generating the scoped data is indicated by blocks 909 and 911 in FIG. 26.

It should be noted that the correlations between the scope units indicated by scope selectors 932 and the applications in the Examiner database can be obtained in a wide variety of different ways. For instance, the application documents, as well as the Office Action and response documents, can be subjected to optical character recognition to identify names of attorneys and law firms. To the extent that this information is identified in data store 124, it can simply be indexed and searched in that way. Similarly, the enterprise or company can provide a list of patents or patent application serial numbers correlated to products, product lines, or business units or other scope units. Similarly, natural language processing techniques can be used to identify the subject matter of the patents or patent applications and match them against a set of keywords or other metadata that describes the product lines, business units, or other scope units. In any case, when the user selects a scope selector, system 100 displays all of the statistics on dashboard 906 but, scopes them so that they include only the statistics (or are based only on underlying data) relevant to the actuated scope selector.

It should also be noted in FIG. 27 that the user may select other buttons as well. Those are described in greater detail below. Briefly, the user can select compare button 960, button 966 which displays where patents of the enterprise have been cited in other applications, or the user can select an individual examiner out of the list of Examiner's displayed at 918, an individual art unit at 920 or an individual law firm or legal representative at 922. In that case, similar statistics as shown in FIG. 27 are displayed, except that they are confined to the statistics corresponding to the individual examiner, art unit, or legal representative that has been selected. Similarly, a user can illustratively select any one of the individual statistics, and the underlying data supporting the statistics are illustratively displayed for the user for further inspection. In one embodiment, the user can continue to click on, or otherwise select, the displayed information to drill down to the source documents in order to get even more detailed information. Receiving other inputs and generating the desired display for those other inputs is indicated by blocks 913, 915, 917, 919 and 921 in FIG. 26. Some of those inputs will now be described in greater detail.

In one embodiment, dashboard 906 includes compare button 960. Compare button 960 implements compare functionality that allows a user to compare the displayed data against other data. For instance, when the user actuates button 960, a popup menu 962 is illustratively displayed which allows the user to compare the data currently being displayed against data corresponding to a given examiner, a specific art unit, or to another assignee. In that case, system 100 illustratively displays two sets of data. This can be done in different ways, such as the two sets side by side, one set after the other, or in another juxtaposed relation so that the user can easily see differences and similarities between the two sets of data. For instance, if the user is viewing general, enterprise-wide statistics for an enterprise known as “ACME Corp.”, and the user wishes to compare those against the same statistics for another company such as Widget Corp., then the user can simply type “Widget Corp” into the “assignee box” in dropdown menu 962, and system 100 will illustratively gather the same statistics for Widget Corp. and display them in juxtaposed relation to the statistics displayed for ACME Corp. Of course, three or more sets of data can be compared in a similar way.

In the embodiment where the user actuates input mechanism 966 (so the user can see where certain patents or publications have been cited), a drop down menu or list such as that shown at 968 is illustratively displayed for the user. This allows the user to indicate how the user would like the results sorted. For instance, if the user wishes to see every patent application where the user's given patent or publication number has been cited, the user can select the appropriate box. Similarly, if the user wishes to see a list of examiners that have cited his or her patent or publication, the user can select that box. That is, if the user selects “examiner”, then all examiners that have cited any patent applications currently displayed on dashboard 906 will be listed. Similarly, the applications can be sorted by art unit or by business unit or by assignee.

Once the user selects the particular way that he or she wishes to sort the results, system 100 generates an interactive table of cited patents or publications as indicated by block 970. In one embodiment, table 970 is simply a table of patents or applications owned by the assignee (or otherwise listed in scoped data) that have been cited elsewhere in the Patent Office. Those patents or publications will be sorted as indicated by the user at block 968. In one embodiment, the table of cases is interactive in that it includes a link to the underlying source documents for the individual patents or patent applications where the citation occurred. For instance, if patent application 012345 of the ACME Corp. was cited in patent application 345678 of Widget Corp. then this is indicated in the results table, and both the patent application for ACME Corp. and the patent application for Widget Corp. are identified with a link that allows the user to navigate to the underlying source document of both the ACME Corp. patent application and the Widget Corp. patent application (where the citation occurred).

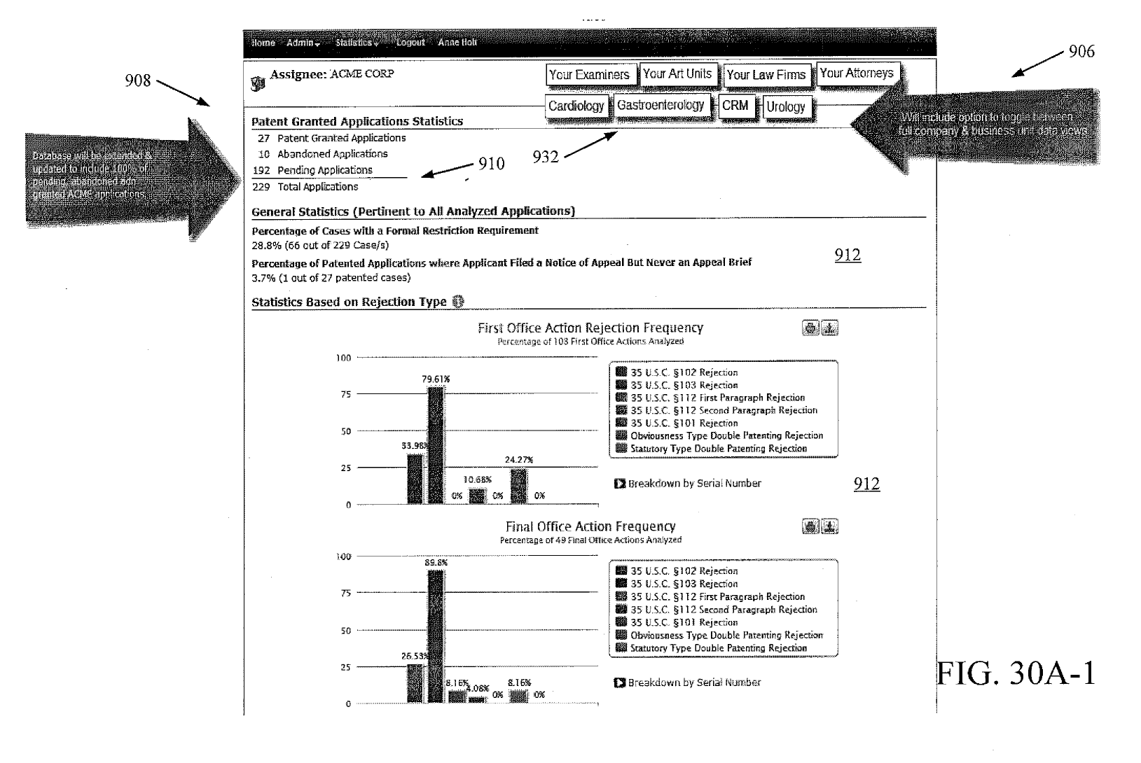

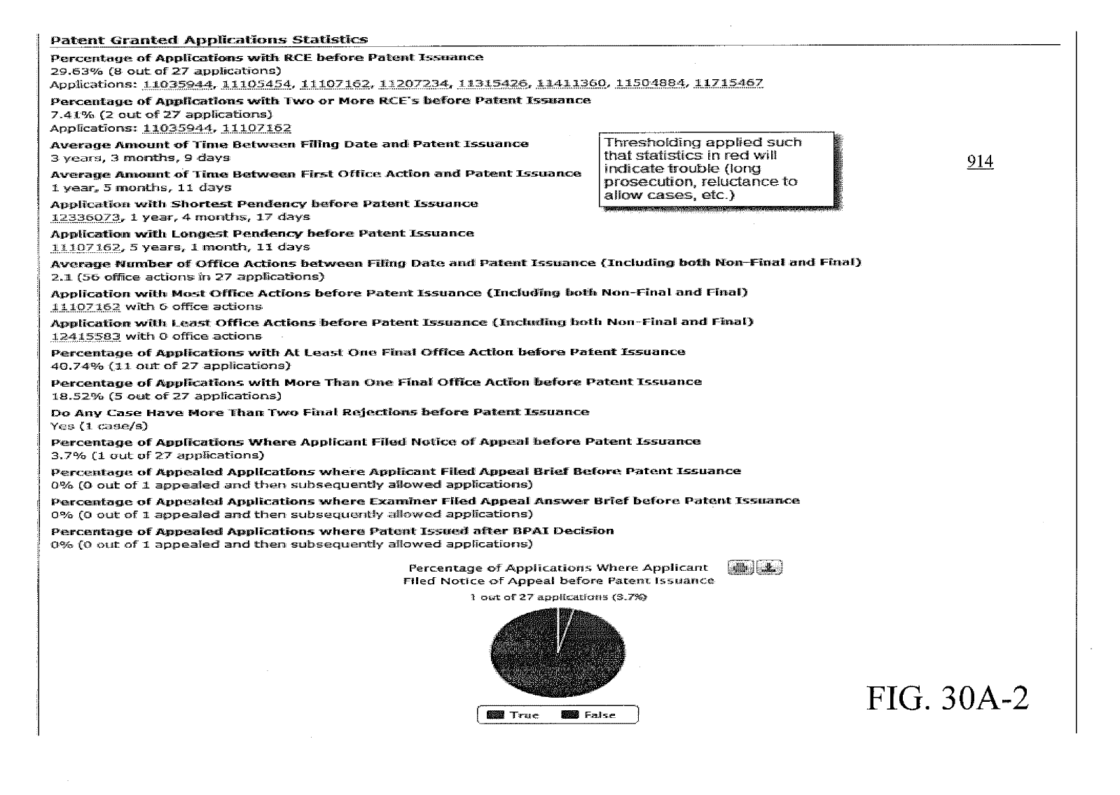

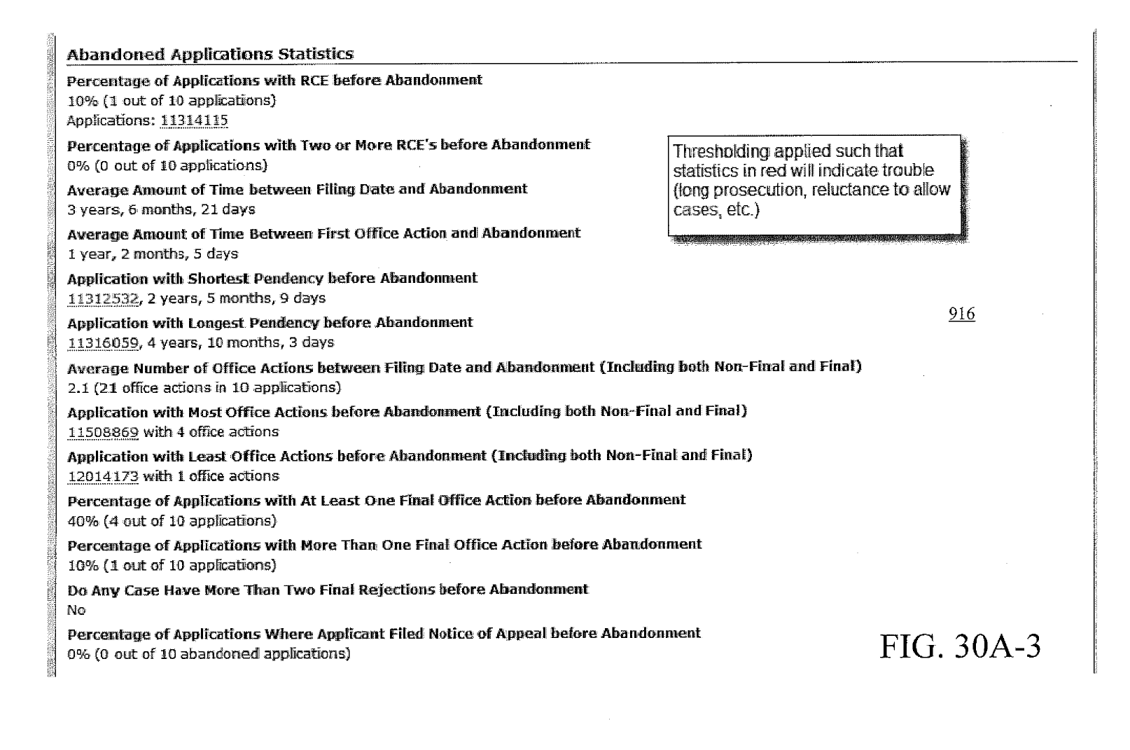

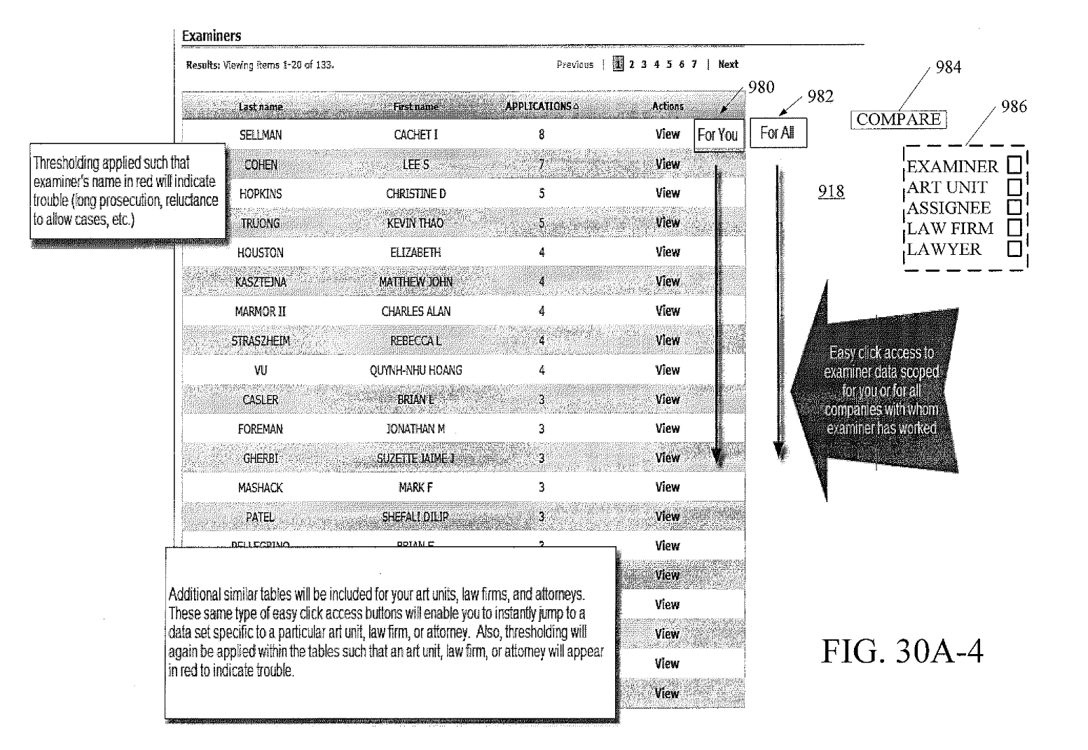

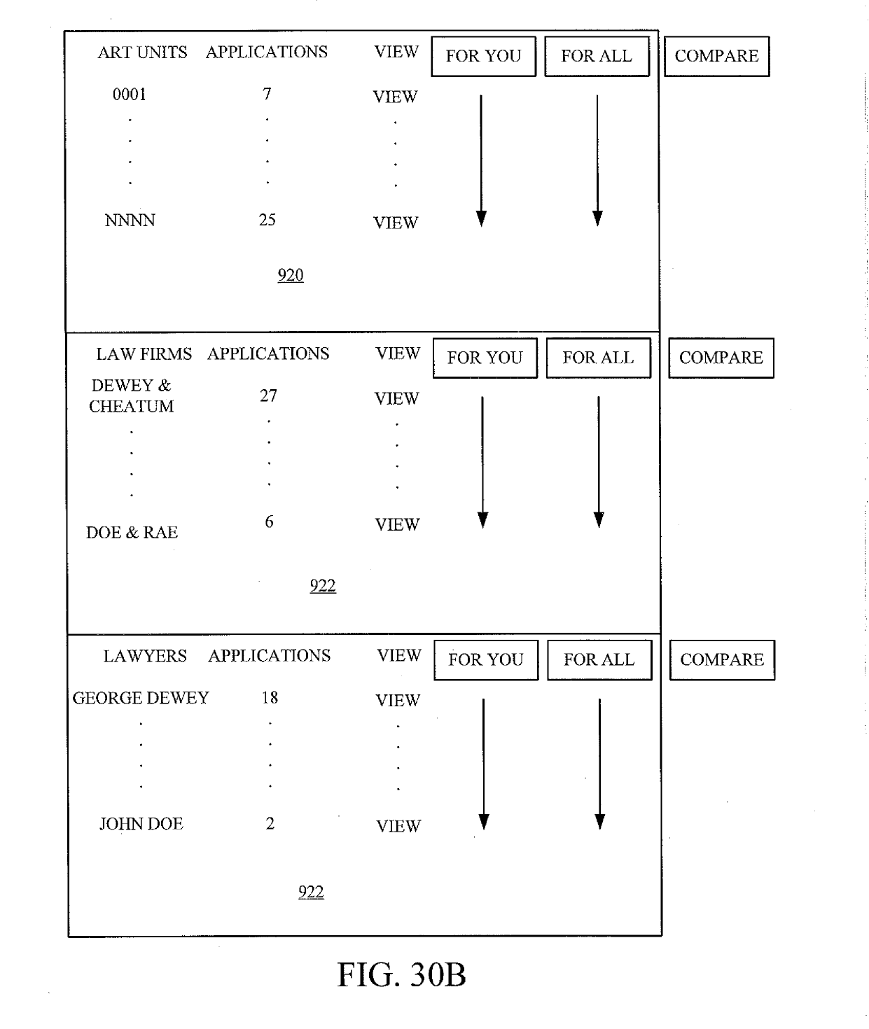

FIGS. 30A and 30B illustrate one illustrative enterprise dashboard 906. It can be seen that banner portion 908 is for ACME Corp. It can also be seen that, in one embodiment, dashboard 906 shown in FIGS. 30A and 30B have scope selectors 932 which correspond to business units of ACME Corp. The scope selectors illustratively correspond to business units comprising cardiology, gastroenterology, cardiac rhythm management (CRM) and urology. Of course, these are listed by way of example only. The remaining portions of dashboard 906 are similar to those shown in FIG. 27, and are similarly numbered.

A number of things are notable. For instance, in one embodiment, for each of the statistics generated, a list of serial numbers that provide the underlying information to support a given statistic are illustratively listed, or can be displayed, if the user clicks on the statistic. Regardless of whether the serial numbers are automatically displayed or displayed in response to a user action (such as clicking on the statistics) if the user clicks on a given serial number, for instance, system 100 illustratively navigates to the source document represented by that serial number.

Similarly, in each of the given sections, one or more of the statistics or listed items can be color coded to convey information. For instance, in section 914, thresholds can be set for each of the statistics (or for a subset of the statistics) and if the statistics cross a given threshold, then the individual statistics (or subset) can be color coded. For instance, a threshold percentage can be set for the statistic “percentage of applications with two or more RCEs before patent issuance”. If the percentage for the currently displayed data exceeds that threshold, then the statistic may be displayed in red. This can be done to indicate that the data reflects a long prosecution history, or a reluctance by the patent office to allow cases, or for any other reason. Of course, the same types of thresholding and color coding can be provided in the other sections as well.

Section 918 shows a list of Examiner's for ACME Corp. In the embodiment shown, section 918 includes the first and last name of the Examiner, and the number of applications that are being handled, or have been handled, by that Examiner. Each entry in section 918 also includes a “view” button which causes system 100 to generate Examiner-specific data for the selected Examiner, as described above with respect to previous Figures. In addition, section 918 illustratively includes a set of buttons 980 and 982 that allow the user to quickly see how a given user is treating them relative to all other individuals or organizations for whom the Examiner is examining cases.

For instance, if the user clicks the “For You” button 980, then all of the Examiner-specific statistics discussed above can be generated and displayed for the selected Examiner, using only applications examined for the current assignee (or scoped in any other way as well, such as for a selected business unit, product line, etc.). If the user selects the “For All” button 982, then the Examiner specific statistics are generated for all applications handled by the selected Examiner.

If the compare button 984 is selected by the user, then illustratively a dropdown menu (such as menu 986) allows the user to input information to compare against that shown for the Examiner. For instance, if the user inputs an Examiner name, then system 100 generates Examiner-specific statistics for the Examiner input in dropdown menu 986. The system illustratively displays these statistics so the user can easily compare them with the statistics for other examiners. Thus, the user can easily see how the Examiner's treatment of his or her company compares to other Examiners.

Similarly, if the user inputs an art unit number in block 986, then the user can see how the selected Examiner's statistics compare to those for the art unit (either for the company as a whole, or for all statistics for the Examiner and the art unit). Similarly, if the user inputs another assignee in block 986, then the user can compare this Examiner's performance for the user's company against the Examiner's performance for other companies. If the user inputs a law firm name or a lawyer name in block 986, then the user can easily compare this Examiner's performance for the user's company versus this Examiner's performance where a given law firm or lawyer is prosecuting the application. Of course, the compare menu 986 can include other options as well and those listed are for the sake of example only.

FIG. 30B also shows art unit section 920 which has similar buttons as that shown in section 918. Also, FIG. 30B shows that legal representative section 922 has been broken out into two sections, one corresponding to law firms, and one corresponding to individual lawyers. Therefore, the user can easily see how many applications are being handled, or have been handled, by individual law firms and even individual lawyers within those law firms. If the user selects one of the law firms or lawyers in the list, then all of the statistics above in FIGS. 30A and 30B will be generated for patent applications being handled by that law firm or lawyer.

In addition, if the user clicks “For You” button 980, those statistics will only be for patent applications of the corporation being handled by the selected law firm or lawyer. If the user clicks the “For All” button 982, then the statistics used will be for all cases (regardless of assignee) being handled by the selected law firm or lawyer.

When the user clicks the “compare” button 984, the user can easily compare the lawyer's performance for the given client against statistics generated for an Examiner, for an art unit, or for another client. Similarly, the user 112 can easily compare the law firm or individual lawyer against another law firm or individual lawyer based on the statistics.

That is, assume that the user has selected the “compare” button 982 for the lawyer “George Dewy”. In that case, dropdown menu 986 can be displayed to the user. Assume also that the user inputs the law firm “Doe and Rae” in the law firm box in dropdown menu 986. System 100 then displays all of the statistics above in FIGS. 30A and 30B based on applications being prosecuted (or which have been prosecuted) by “George Dewy” and will also generate those statistics for applications being prosecuted (or which have been prosecuted) by the law firm “Doe and Rae” and displays them juxtaposed to one another so that the user can easily compare the law firm “Doe and Rae” against the lawyer “George Dewy” Again, by juxtaposed, it is meant that the statistics can be displayed side by side, one after the other, interleaved, or in any other desired way to make comparison easy.

It will also be noted, of course, that the data generated can be scoped as discussed above. For instance, the user can compare the performance of the law firm “Doe and Rae” against the performance of the lawyer “George Dewy” for applications only being handled on behalf of the user's company or organization, or all cases being handled by the selected law firm and lawyer (regardless of assignee), or for the cases within a given business unit being handled by them, or otherwise.

It will of course be noted that thresholding can be applied in all of sections 912-922. Therefore, if the statistics for a given art unit, law firm or lawyer tend to indicate that specific performance characteristics should be highlighted, the art unit, law firm or lawyer's name can be displayed in a highlighted way. By way of example only, assume that the data for the lawyer “George Dewy” indicates that he or she normally files an abnormally large number of RCEs before patent issuance in the cases for this client, as compared to the number of RCEs for patent applications for other assignees. Users of system 100 may wish for this to be flagged and easily detectable. In that case, thresholding is set for the appropriate statistics so that George Dewy's RCE percentage before patent issuance for the user's company or organization is compared with the George Dewy's RCE percentage for other companies. If the two differ by more than a threshold amount, then George Dewy's name may be displayed in red, purple, or otherwise color coded or displayed in bold, or in another way that serves to visually distinguish George Dewy's name from other names on the display. Similarly, there may be some other visual indicia (such as an asterisk or otherwise) provided to indicate that further investigation should be performed. Of course, the statistics that can be used for thresholding or comparison can be pre-defined and selectable through an appropriate user input mechanism (such as a drop down menu), or they can be user defined, as desired.

It should be noted that various different components of the present system can be embodied on different devices. For example, they can be embodied on desktop computers, laptop computers, tablet computers, smart phones, cellular phones, other personal digital assistants, or other devices. It will also be noted that various components of this system can reside on different devices, other than on a single device. For example, the components can be divided among different types of devices where different functions can be performed on different devices. Similarly, the system (or portions thereof) can be embodied in a cloud computing environment. Cloud computing provides computation, software, data access, and storage services that do not require end-user knowledge of the physical location or configuration of the system that delivers the services. In various embodiments cloud computing delivers the services over a wide area network, such as the internet, using appropriate protocols. For instance, cloud computing providers deliver applications over a wide area network and they can be accessed through a web browser or any other computing component. Components of device 10 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

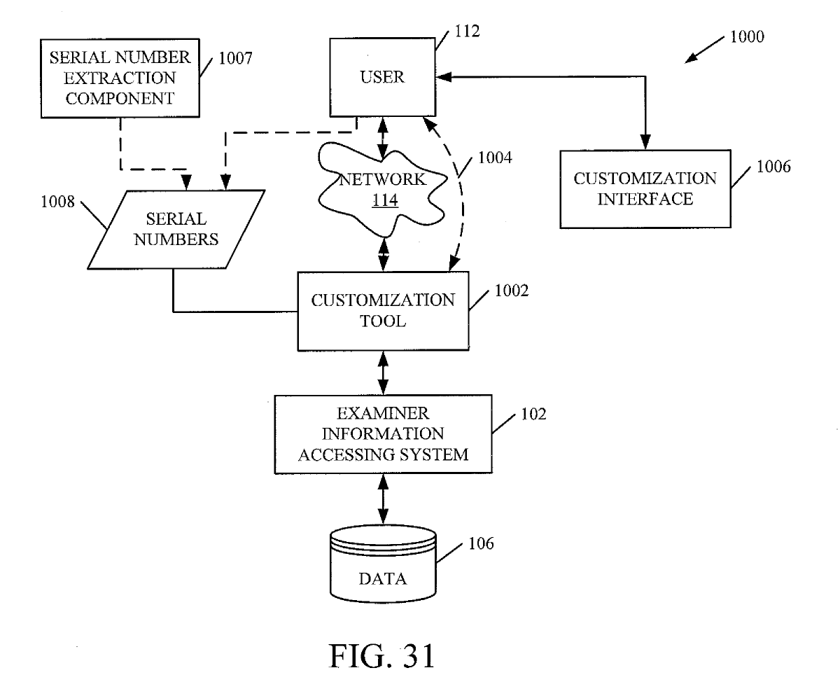

FIG. 31 shows one embodiment of an illustrative customization system 1000. Some of the items in customization system 1000 are similar to those shown in FIGS. 1A and 1B, and are similarly numbered. Thus, customization system 1000 shows that user 112 has access to a customization tool 1002 either through network 114 or directly (as indicated by dashed arrow 1004). It should be noted, of course, that customization tool 1002 is shown operably connected to examiner information accessing system 102 which is, itself, shown in accessible relation to examiner data 106. Of course, all of the communications can be accomplished either through direct communication, or over a network.

In any case, system 1000 also shows that customization tool 1002 provides a customization interface 1006 to user 112 (again, either directly or over network 114), which includes user input mechanisms that illustratively allow user 112 to provide user inputs for customizing data, as desired. System 1000 also includes an optional serial number extraction component 1008.

As discussed above with respect to FIG. 27, the statistics calculated by the system can be scoped by scope selectors 932. The scope selectors 932 can be, for example, business units, product lines, etc. In addition, the statistics can be calculated for individual law firms or even individual lawyers. System 1000 allows user 112 to customize which serial numbers are assigned to which scope selectors, law firms or lawyers, etc. For instance, if the system provides business units as scope selectors 932, then user 112 can customize which particular serial numbers are assigned to which business unit. This can be beneficial, because sometimes companies or organizations change how they are organized so that different business units are formed or eliminated, or combined. Therefore, the patent applications that go along with those business units can be aggregated with other business units, or divided up, and system 1000 allows user 112 to easily do this. While the discussion of FIGS. 31-33 will be described with respect to dividing patent application serial numbers (or publication or patent numbers) among different business units, it will be understood that the patent applications, publications or patents can be divided among other things, such as lawyers, law firms, product lines, or any other desired categories, which may be desired by user 112.

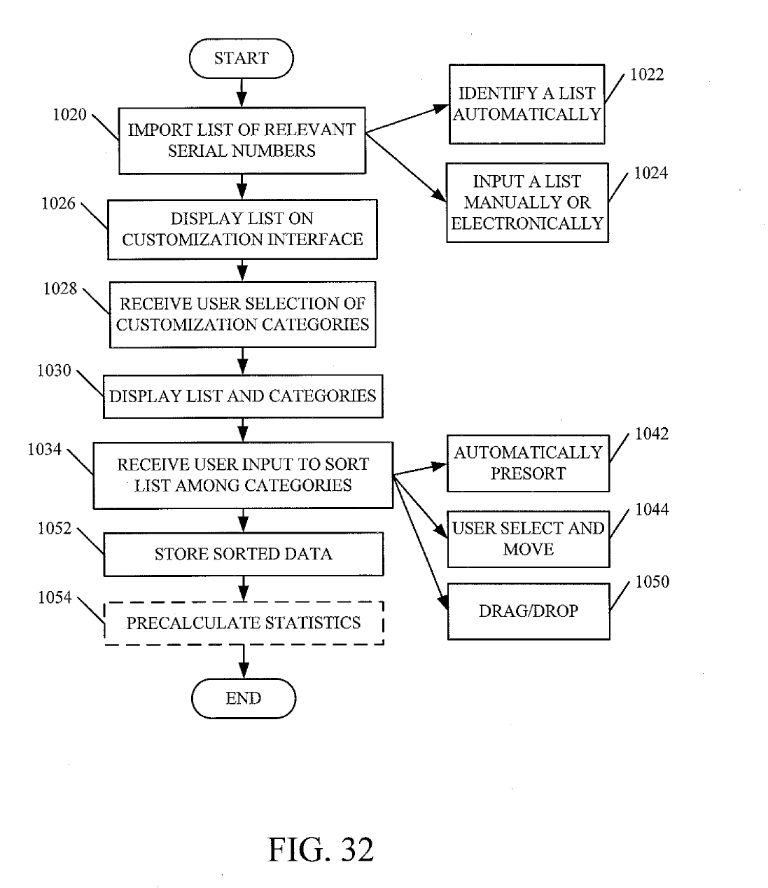

FIG. 32 is a flow diagram illustrating one embodiment for customizing the data. System 1000 first imports a list of relevant serial numbers. This is indicated by block 1020 in FIG. 32. This can be done in a variety of different ways. For instance, if user 112 desires to input a list of serial numbers corresponding to a given business unit, the user can ask information accessing system 102 to identify those serial numbers automatically. There are a wide variety of different ways for doing this. In one embodiment, the user 112 provides a list of key words that correspond to the business unit, and system 102 accesses the patent applications, office actions, and possibly responses, and performs natural language processing on the texts in those items to determine whether they sufficiently match the key words input by the user. If so, the serial numbers or publication numbers (or patent numbers for issued patents) corresponding to the matches are added to the list as tentative matches for the given business unit. Of course, other ways of automatically identifying the list of serial numbers corresponding to the given business unit or other scope unit can be used as well, and automatically identifying the list is indicated by block 1022 in FIG. 32.

Alternatively, or in addition, user 112 can input the list manually, or electronically. For instance, if the user already has a list of serial numbers, broken out by business unit, or if the user just has a list of all the serial numbers that the user wishes to categorize using customization system 1000, the user can simply input that list to customization tool 1002, manually. The serial numbers (whether generated manually or automatically) are indicated by block 1008 in FIG. 31, and inputting the list manually is indicated by block 1024 in FIG. 32.

The list of serial numbers 1008 displayed on customization interface 1032 may also include other information as well, such as the title of the patent application corresponding to the serial number, such as a list of key words extracted from the documents corresponding to that serial number, etc. Alternatively, this information can be displayed when the user 112 hovers the cursor over a given serial number, right clicks on the given serial number, or otherwise selects the given serial number. In addition, if the user clicks on the given serial number, customization tool 1002 illustratively navigates the user 112 to the underlying source document or documents corresponding to that serial number. All of these are exemplary only.

Once customization tool 1002 has the list of serial numbers 1008, it illustratively displays that list on a customization interface 1006 for the user 1112 to review. This is indicated by block 1026 in FIG. 32. In doing so, customization tool 1002 illustratively allows the user to input, through an appropriate user input mechanism, the different categories (scope units) that the user will be dividing the serial numbers into. For instance, customization tool 1002 can automatically generate a list of the business units in the company for which user 112 is working, or it can provide a text box or other user input mechanism that allows a user to define categories or subcategories for division or customization. In any case, customization tool 1002 receives from user 112, a selection of the various customization categories (scope units) among which the user desires to divide the list of serial numbers 1008. This is indicated by block 1028 in FIG. 32.

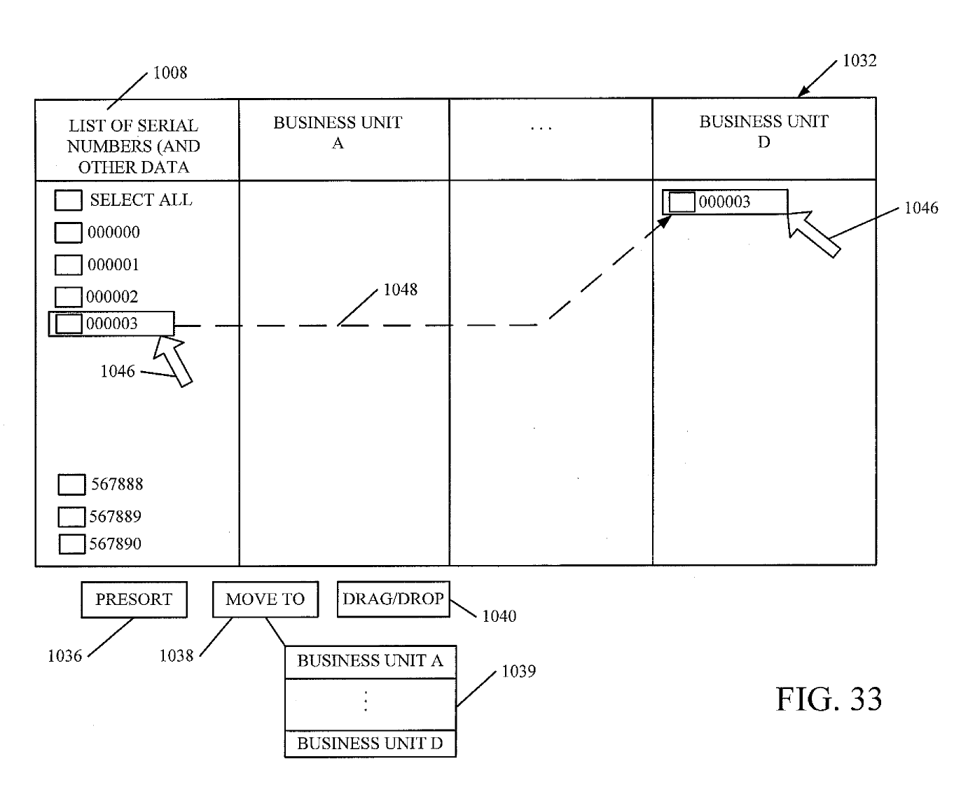

Having received both a list of serial numbers and the customization categories, customization tool 1002 illustratively displays the list and the categories for the user on customization interface 1006. This is indicated by block 1030 in FIG. 32. FIG. 33 shows one illustrative embodiment of a customization interface display 1032 that shows both the list of serial numbers 1008 and the customization categories which are identified as business unit A-business unit D.

Customization tool 1002 then receives user inputs, through various user input mechanisms, to sort the list of serial numbers 1008 among the customization categories (such as business unit A-business unit D). This is indicated by block 1034 in FIG. 32, and it can be done in a wide variety of different ways.

In the embodiment shown in FIG. 33, the customization interface 1032 has a plurality of different user actuable buttons, including a “pre-sort” button 1036, a “move to” button 1038 and a “drag/drop” button 1040. In one embodiment, the user can select one of these buttons to cause customization tool 1002 to divide the serial numbers 1008 among the customization categories.

In one embodiment presort buttons 1036 causes customization tool 1002 to automatically presort the serial numbers among the customization categories. Again, this can be done by matching keywords extracted from the patent application documents corresponding to a given serial number against key words for each of the individual customization categories. Customization tool 1002 can also illustratively calculate a confidence score associated with each automatic categorization, and then display the serial numbers, as presorted according to the customization categories. Where the confidence score is below a given threshold, customization tool 1002 can highlight that serial number, or otherwise show it in a visually contrasting manner, to indicate that customization tool 1002, while it has made its best guess, is not very certain that this particular serial number is categorized correctly. Thus, the user 112 can then find the highlighted serial numbers and click on them. In one embodiment, this brings the user to the source document used for the categorization process (or it shows more descriptive data then just the serial number), so that the user can verify that the serial number is in fact in the correct customization category. Other automatic sorting techniques can be used as well, and this one is described for the sake of example only. Automatically presorting the serial numbers is indicated by block 1042 in FIG. 32.

Another user input mechanism shown in FIG. 33 is the “move to” button 138. In that embodiment, the user illustratively checks a check box associated with each desired serial number, and then selects the “move to” button 1038. In response, customization tool 1002 illustratively displays a dropdown menu (such as 1039) listing the various customization categories into which the serial numbers can be sorted. When the user selects one of those customization categories from the dropdown menu 1039, customization tool 1002 automatically moves the selected serial numbers into the selected customization category and displays them for the user. This is referred to as a “user select and move” sorting input and is indicated by block 1044 in FIG. 32.

In another embodiment, the user can simply use drag and drop inputs to move the individual serial numbers in list 1008 into the appropriate customization categories. This is shown in FIG. 33 where the user first places cursor 1046 over serial number 000003 and clicks and holds on it, and then moves it in the direction indicated by arrow 1048 to the customization category “business unit D” and releases the serial number in that business unit category. Dragging and dropping the serial numbers among the various customization categories is indicated by block 1050 in FIG. 33.

Once the user 112 has sorted the list of serial numbers 1008 among the various customization categories, or when the user wants to finish this sorting session, the user can click an end button or otherwise indicate to customization tool 1002 that the user is finished sorting, at least for now. In response, customization tool 1002 stores the sorted data or stores the correspondence of the serial numbers to each of the customization categories. This is indicated by block 1052 in FIG. 32.

In one embodiment, examiner information accessing system 102 can then begin precalculating all statistics discussed above, for the serial numbers, sorted according to the customization categories (or scope units) by customization tool 1002. This, of course, is optional and is indicated by block 1054 in FIG. 32. By precalculating the statistics, the system can more quickly present results to a user who wishes to see the calculated statistics, calculated for the customization categories described above. However, the system can also calculate the statistics on-the-fly, and need not necessarily precalculate them.

The corporate dashboard can also be used, instead of by patent practitioners, by corporate personnel which may be attempting to set budgets or implement other financial or legal strategies (or other strategies for that matter), using their patent application portfolio. It can easily be seen how all of the above user interfaces, statistics, and processing, as well as the underlying data, can be used to inform these types of decisions. For instance, it may be more costly to obtain a patent application for one business unit, than for another business unit of the same company. This can be very valuable information in allocating intellectual property budget among various business units. Similarly, it may be readily apparent that patents are granted much more quickly in certain business units than in other business units. Therefore, depending on the particular technology (such as whether it will be around a long time or will be obsolete relatively quickly) this information can also be very useful in allocating patent or intellectual property budget among business units. The same is true of individual product lines, or other scope units that may be used by a user of the present system.

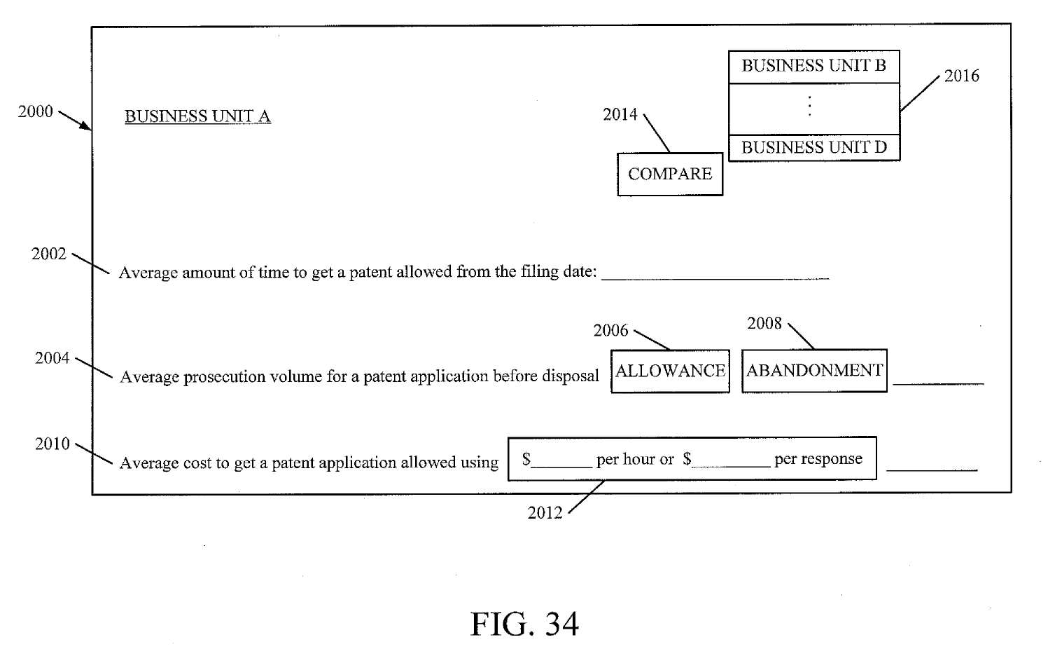

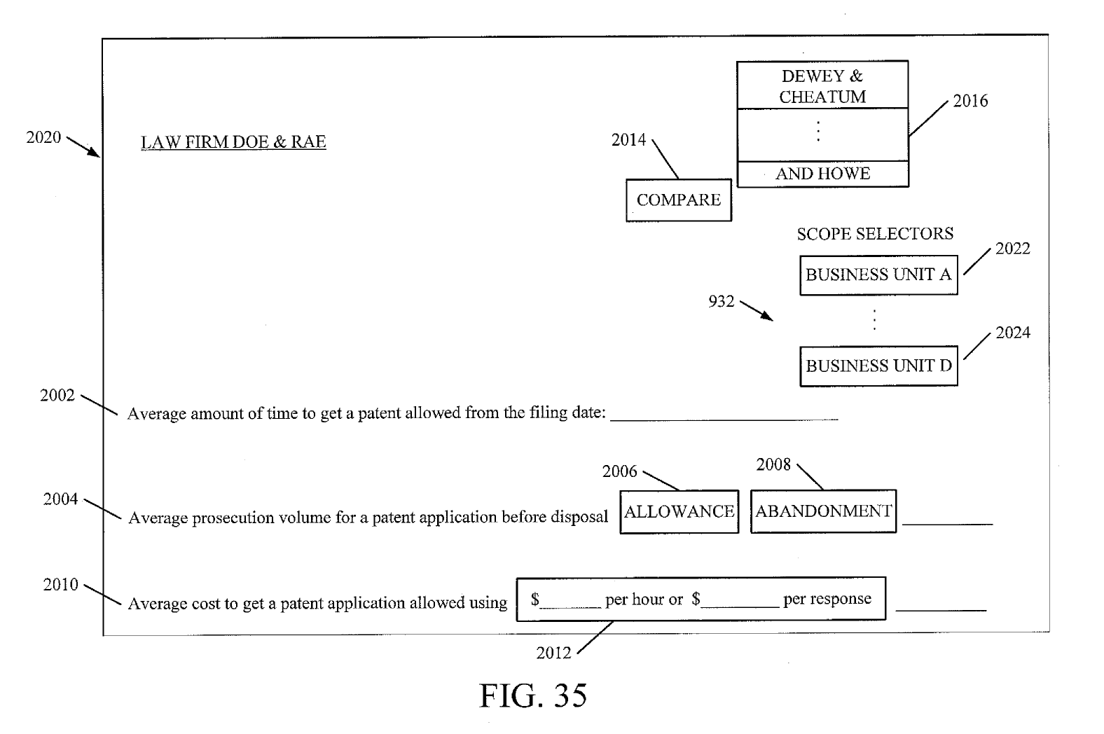

FIGS. 34 and 35 are illustrative user interface displays that can be generated by the system to make it even easier for a patent portfolio manager to make decisions. FIG. 34 is a user interface display 2000 that can be generated for a company as a whole, or for any other scope units from that company. In the example shown in FIG. 34, the display is generated for a business unit (Business Unit A) of the company. As shown in FIG. 34, the user interface display 2000 includes an average amount of time display portion 2002 which displays an average amount of time to get a patent allowed from the filing date, for Business Unit A. Of course, this information can be compiled from the statistics (or extracted from the statistics) discussed above. By examining the patent prosecution statistics for only the serial numbers corresponding to Business Unit A, the system can easily calculate an average amount of time that a patent application takes to be allowed as a patent, from its filing date. This is displayed in portion 2002.

FIG. 34 also illustratively includes an average prosecution volume portion 2004. By prosecution volume it is meant (for example) an average number of office actions (final and non-final office actions, including appeals), which are required before disposal of a patent application. When those statistics are all aggregated together for both abandoned and granted patent applications, they can be displayed as an aggregated amount. Alternatively, the display portion 2004 can be provided with two actuable user input mechanisms (such as buttons) 2006 and 2008. When allowance button 2006 is actuated, the system displays in portion 2004 the average prosecution volume for a patent application before allowance. Thus, the statistics are aggregated for only allowed cases. When abandonment button 2008 is actuated, portion 2004 displays the average prosecution volume for a patent application before abandonment. Thus, the statistics are aggregated by the system for only abandoned cases.

User interface display 2000 also includes an average cost display portion 2010. Portion 2010 displays an average cost to get a patent application allowed for patent applications that have been allowed in Business Unit A. Of course, a similar statistic can be provided for abandoned applications, and an aggregate statistic can be provided that aggregates average costs for both abandoned and allowed cases.

In any case, in one embodiment, the user is allowed to specify an average dollar per hour or Euro per hour (or other localized currency per hour) or an average amount of currency per response. This can be entered in box 2012 in the appropriate spot. Of course, the system can itself generate a dollar amount and use it as a default amount, automatically, or the user can provide a desired amount in box 2012. In either case, the system multiplies the average prosecution volume by the costs entered in box 2012 to obtain an average cost for getting a patent allowed in Business Unit A. Where the user has entered an amount in dollars per hour, the system also multiples the average prosecution volume by an average number of hours spent per response (which can also be entered by the user) and by the average cost per hour. In any case, display portion 2010 displays a cost estimate for patent prosecution in Business Unit A. This can be very helpful in the budgeting process or in other strategic decision making processes.

FIG. 34 also shows that, in one embodiment, user interface display 2000 includes a user actuable compare button 2014. Compare button 2014, when actuated, causes the processor to generate a dropdown menu, such as menu 2016. This allows the user 112 to compare the statistics shown in FIG. 34 for Business Unit A against any other scope unit desired by the user. In the embodiment shown in FIG. 34, dropdown menu 2016 includes the other business units B-D. Therefore, by actuating button 2014 and selecting one of the scope units in menu 2016, the user can have the system calculate the same statistics for both Business Unit A and the selected scope unit from menu 2016, and display them in juxtaposed relation to one another. This can also be very valuable to the user in allocating budget or in making other strategic decisions. Also, it will be noted that while FIG. 34 shows display 2000 for a specific business unit, a similar display can be generated for substantially any of the scope units desired by the user.

FIG. 35 shows a similar user interface 2020, which is similar to user interface display 2000 shown in FIG. 34 and similar items are similarly numbered. However, the statistical display portions 2002, 2004 and 2010 shown in FIG. 35 are calculated for applications being prosecuted by a selected law firm (Doe and Rae). For instance, average amount of time display portion 2002 displays the average amount of time to get a patent allowed from the filing date, of the applications being prosecuted by the law firm Doe and Rae. The average prosecution volume display portion 2004 displays the average prosecution volume for a patent application before disposal for those patent applications of the company that are being prosecuted by law firm Doe and Rae. Again, buttons 2006 and 2008 can be actuated to display the information for the prosecution of a patent application before allowance and before abandonment, respectively. Average cost display portion 2010 shows the average cost to get a patent application allowed using a specified dollar amount in box 2012 for the law firm Doe and Rae.

It should be noted that the user interface 2020 of FIG. 35 can also be scoped. In other words, the statics displayed therein can be calculated for all of the patent applications (for any assignee) being prosecuted by the law firm Doe and Rae, for the patent applications assigned to the assignee, or for the patent applications corresponding to one of the scope selectors 932 in FIG. 35. Therefore, the statistics in display portions 2002, 2004 and 2010 can be scoped so that they only pertain to patent applications associated with Business Unit A (scope selector 2022) or Business Unit D (scope selector 2024) or any other desired scope selector 932.

It can also be seen that user interface display 2020 provides compare button 2014. When compare button 2014 is actuated, it illustratively generates another dropdown menu 2016 or other input mechanism that allows the user to select a basis for comparison. In the embodiment shown in FIG. 35, menu 2016 includes selectable buttons for additional law firms. Therefore, user 112 can easily compare the statistics 2002, 2004 and 2010 for the law firm Doe and Rae against similar statistics for other law firms. Of course, the bases for comparison in menu 216 can include other assignees, such as competitors, as well.

Although the present invention has been described with reference to preferred embodiments, workers skilled in the art will recognize that changes may be made in form and detail without departing from the spirit and scope of the invention.

What is claimed is:

1. A computer implemented method performed by a computer with a processor, the method comprising:
receiving, at the processor, an assignee name input;
accessing, with the processor, an examiner data system based on the assignee name;
identifying, with the processor, a set of patent examiners in the examiner data system that examine patent applications assigned to an assignee represented by the assignee name;
calculating patent prosecution statistics for the identified set of patent examiners based only on patent applications assigned to the assignee; and
automatically displaying, on a user interface display, the patent prosecution statistics along with a list of the identified set of patent examiners on a user interface display, each displayed patent examiner in the identified set being displayed with a corresponding actuable user input which when actuated, causes the processor to automatically display patent prosecution statistics for the patent examiner corresponding to the actuated user input.

2. The computer implemented method of claim 1 wherein automatically displaying the patent prosecution statistics comprises:
displaying a plurality of actuable scope selector input mechanisms, each corresponding to a scope unit associated with a subset of the patent applications assigned to the assignee;
receiving actuation of a selected one of the scope selector input mechanisms;
calculating scoped patent prosecution statistics based only on the subset of patent applications corresponding to the selected scope selector input mechanism; and
displaying the scoped patent prosecution statistics.

3. The computer implemented method of claim 1 and further comprising:
identifying a set of legal representatives that prosecute the patent applications assigned to the assignee; and
displaying a list of the set of legal representatives, each legal representative in the set having a corresponding actuable user input mechanism which when actuated, causes the processor to display legal representative patent prosecution statistics for only the corresponding legal representative and based only on patent applications assigned to the assignee and prosecuted by the corresponding legal representative.

4. The computer implemented method of claim 3 and further comprising:
displaying an actuable legal representative compare mechanism which, when actuated, causes the processor to compare the legal representative patent prosecution statistics for the corresponding legal representative with legal representative statistics for another selected legal representative.

5. The computer implemented method of claim 4 wherein actuation of the legal representative compare mechanism causes the processor to generate a selection user interface that receives a user input selecting a set of statistics to be compared with the legal representative patent prosecution statistics for the corresponding legal representative.

6. The computer implemented method of claim 2 and further comprising:
generating a predicted prosecution volume for a scope unit corresponding to the selected scope selector input mechanism; and
displaying the predicted prosecution volume for the scope unit.

7. The computer implemented method of claim 6 wherein the predicted prosecution volume comprises:
an indication of an estimated number of office actions that will be required before allowance of a patent application associated with the scope unit.

8. The computer implemented method of claim 6 wherein the predicted prosecution volume comprises:
an indicator of an estimated financial cost for prosecuting the patent application to allowance.

9. The computer implemented method of claim 6 wherein each scope unit represented by one of the scope selector user input mechanisms comprises:
a business unit of the assignee.

10. The computer implemented method of claim 6 wherein each scope unit represented by one of the scope selectors user input mechanisms comprises:
a product line of the assignee.

11. The computer implemented method of claim 6 wherein each scope unit represented by one of the scope selector user input mechanisms comprises another assignee.

12. The computer implemented method of claim 6 wherein displaying the predicted prosecution volume comprises:
displaying an actuable compare mechanism which when actuated, generates a predicted prosecution volume for another entity, other than the scope unit corresponding to the selected scope selector input mechanism; and
displaying the predicted prosecution volume for the other entity in juxtaposed relation to the predicted prosecution volume for the scope unit.

13. The computer implemented method of claim 12 wherein the other entity comprises another scope unit.

14. The computer implemented method of claim 12 wherein the other entity comprises another assignee.
